(19) United States
(12) Patent Application Publication
(10) Pub. No.: US 2025/0251568 A1
(43) Pub. Date: Aug. 7, 2025

(54) MICROSCOPE OBJECTIVE LENS, MICROSCOPE OPTICAL SYSTEM, AND MICROSCOPE DEVICE

(71) Applicant: NIKON CORPORATION, Tokyo (JP)

(72) Inventor: Hidetsugu TAKAGI, Yokohama-shi (JP)

(73) Assignee: NIKON CORPORATION, Tokyo (JP)

(21) Appl. No.: 19/187,470

(22) Filed: Apr. 23, 2025

Related U.S. Application Data
(63) Continuation of application No. PCT/JP2023/045401, filed on Dec. 19, 2023.

(51) Int. Cl. G02B 9/10

(52) U.S. Cl. CPC G02B 9/10

(57) ABSTRACT

A microscope objective lens including a first lens group, and a second lens group having a negative refractive power disposed in order from an object along an optical axis. The second lens group includes a first cemented meniscus lens having a concave surface facing an image, and a second cemented meniscus lens having a concave surface facing the object which are disposed in order from the object along the optical axis, and the first lens group includes a specified positive meniscus lens that satisfies the following conditional expressions, 0<θgFA+0.0015×vdA−0.6395, 1.60<ndA<1.85, and 39.50<vdA<75.00, where ndA: a refractive index of the specified positive meniscus lens with respect to d-line, vdA: an Abbe number of the specified positive meniscus lens, and θgFA: a partial dispersion ratio of the specified positive meniscus lens.

### TECHNICAL FIELD

The present invention relates to a microscope objective lens, a microscope optical system, and a microscope device.

### TECHNICAL BACKGROUND

In recent years, various objective lenses for microscopes with a high magnification and a large numerical aperture have been proposed (see Patent document 1). Such objective lenses are required to favorably correct chromatic aberrations.

### PRIOR ARTS LIST

### Patent Document

Patent document 1: Japanese Laid-Open Patent Publication No. 2019-191266

### SUMMARY OF THE INVENTION

A microscope objective lens according to a first present invention includes a first lens group, and a second lens group having a negative refractive power which are disposed in order from an object along an optical axis, wherein the second lens group includes a cemented meniscus lens having a concave surface facing an image, and a meniscus lens component having a concave surface facing the object which are disposed in order from the object along the optical axis, and the first lens group includes a specified positive meniscus lens that satisfies the following conditional expressions.

$$0 < θ g F A + 0.0 \; 015 \times ν dA - 0.6395$$

$$1.6 < nd A < 1.85 , and$$

$$39.5 < ν dA < 75. ,$$

where ndA: a refractive index of the specified positive meniscus lens with respect to d-line,
vdA: an Abbe number of the specified positive meniscus lens, and
θgFA: a partial dispersion ratio of the specified positive meniscus lens, defined by the following expression when it is assumed that a refractive index of the specified positive meniscus lens with respect to g-line is ngA, a refractive index of the specified positive meniscus lens with respect to F-line is nFA, and a refractive index of the specified positive meniscus lens with respect to C-line is nCA,

$$θ gFA = ( ngA - nFA ) / ( nFA - nCA ) .$$

A microscope objective lens according to a second present invention includes a first lens group, and a second lens group having a negative refractive power which are disposed in order from an object along an optical axis, wherein the second lens group includes a cemented meniscus lens having a concave surface facing an image, and a meniscus lens component having a concave surface facing the object which are disposed in order from the object along the optical axis, and the first lens group includes a specified positive meniscus lens that satisfies the following conditional expressions.

$$0 < θ gFA + 0.0016 \times vdA - 0.646$$

$$1.6 < ndA < 1.85 , and$$

$$39.5 < vdA < 75. ,$$

where ndA: a refractive index of the specified positive meniscus lens with respect to d-line,
vdA: an Abbe number of the specified positive meniscus lens, and
θgFA: a partial dispersion ratio of the specified positive meniscus lens, defined by the following expression when it is assumed that a refractive index of the specified positive meniscus lens with respect to g-line is ngA, a refractive index of the specified positive meniscus lens with respect to F-line is nFA, and a refractive index of the specified positive meniscus lens with respect to C-line is nCA,

$$θ gFA = ( ngA - nFA ) / ( nFA - nCA ) .$$

A microscope optical system according to the present invention includes: the microscope objective lens described above; and an imaging lens that focuses light from the microscope objective lens to form an image.

A microscope device according to the present invention includes the microscope objective lens described above.

### BRIEF DESCRIPTION OF THE DRAWINGS

FIG. 1 is a sectional view showing a configuration of a microscope objective lens according to First Example;

FIG. 2 includes graphs showing various aberrations of the microscope objective lens according to First Example;

FIG. 3 is a graph showing the chromatic aberrations of magnification of the microscope objective lens according to First Example;

FIG. 4 includes graphs showing coma aberrations of the microscope objective lens according to First Example;

FIG. 5 is a sectional view showing a configuration of a microscope objective lens according to Second Example;

FIG. 6 includes graphs showing various aberrations of the microscope objective lens according to Second Example;

FIG. 7 is a graph showing the chromatic aberrations of magnification of the microscope objective lens according to Second Example;

FIG. 8 includes graphs showing coma aberrations of the microscope objective lens according to Second Example;

FIG. 9 is a sectional view showing a configuration of a microscope objective lens according to Third Example;

FIG. 10 includes graphs showing various aberrations of the microscope objective lens according to Third Example;

FIG. 11 is a graph showing the chromatic aberrations of magnification of the microscope objective lens according to Third Example;

FIG. 12 includes graphs showing coma aberrations of the microscope objective lens according to Third Example;

FIG. 13 is a sectional view showing a configuration of a microscope objective lens according to Fourth Example;

FIG. 14 includes graphs showing various aberrations of the microscope objective lens according to Fourth Example;

FIG. 15 is a graph showing the chromatic aberrations of magnification of the microscope objective lens according to Fourth Example;

FIG. 16 includes graphs showing coma aberrations of the microscope objective lens according to Fourth Example;

FIG. 17 is a sectional view showing a configuration of a microscope objective lens according to Fifth Example;

FIG. 18 includes graphs showing various aberrations of the microscope objective lens according to Fifth Example;

FIG. 19 is a graph showing the chromatic aberrations of magnification of the microscope objective lens according to Fifth Example;

FIG. 20 includes graphs showing coma aberrations of the microscope objective lens according to Fifth Example;

FIG. 21 is a sectional view showing a configuration of a microscope objective lens according to Sixth Example;

FIG. 22 includes graphs showing various aberrations of the microscope objective lens according to Sixth Example;

FIG. 23 is a graph showing the chromatic aberrations of magnification of the microscope objective lens according to Sixth Example;

FIG. 24 includes graphs showing coma aberrations of the microscope objective lens according to Sixth Example;

FIG. 25 is a sectional view showing a configuration of an imaging lens; and

FIG. 26 is a schematic configuration diagram showing a confocal fluorescence microscope that is an example of the microscope device.

### DESCRIPTION OF THE EMBODIMENTS

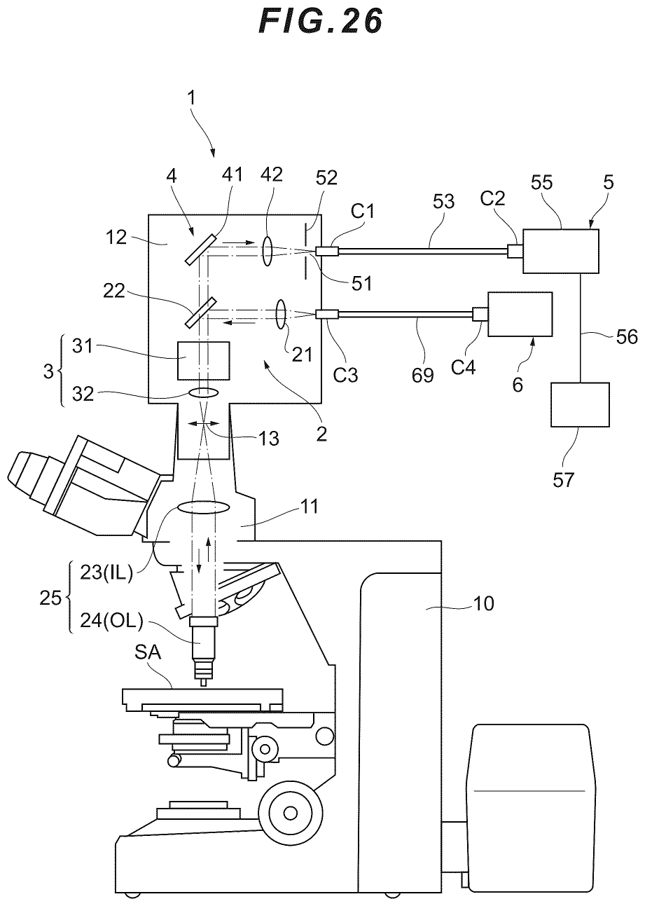

Preferred embodiments according to the present invention are described below. First, a microscope optical system and a confocal fluorescence microscope (microscope device) that include a microscope objective lens according to each embodiment are described with reference to FIG. 26. As shown in FIG. 26, the confocal fluorescence microscope 1 includes: an excitation light introducer 2 that introduces illumination laser light from a light source unit 6 to a sample SA; a scanning device 3 that deflects laser light focused on the sample SA, and scans the sample SA therewith; an optical detection device 5 that detects a light intensity signal from the sample SA; and a collective optical system 4 that introduces light from the sample SA to the optical detection device 5.

The light source unit 6 may be provided in the confocal fluorescence microscope 1, or may be provided separately from the confocal fluorescence microscope 1. The light source unit 6 includes a laser light source (not shown), and a beam diameter adjustment mechanism (not shown). The light source unit 6 oscillates illumination laser light.

The excitation light introducer 2 includes: a collimating lens 21; a dichroic mirror 22; and a microscope optical system 25 that includes an imaging lens 23 and an objective lens 24. The collimating lens 21 and the dichroic mirror 22 are arranged in a microscope housing 12 provided above a lens barrel 11 of a microscope main body 10. Note that the light source unit 6 and the microscope housing 12 are connected to each other by an optical fiber 69 using connectors C3 and C4. The collimating lens 21 converts laser light (light flux) oscillated by the light source unit 6 into parallel light. The dichroic mirror 22 reflects the laser light from the collimating lens 21, toward the sample SA. The microscope optical system 25 focuses the laser light reflected by the dichroic mirror 22 on the sample SA, by the imaging lens 23 and the objective lens 24. The imaging lens 23 is arranged in the lens barrel 11 of the microscope main body 10. Note that the imaging lens 23 is also called a second objective lens. The objective lens 24 is mounted beneath the lens barrel 11.

The scanning device 3 includes: a scanning mechanism (scanner) 31; and a scanning optical system 32. The scanning device 3 is arranged between the dichroic mirror 22 in the microscope housing 12 and the imaging lens 23. The scanning mechanism (scanner) 31 includes, for example, a galvanometer mirror (not shown) or a resonant mirror (not shown). The scanning mechanism (scanner) 31 deflects the incident laser light. That is, the scanning mechanism (scanner) 31 deflects the laser light focused on the sample SA, and scans the sample SA therewith. The scanning optical system 32 is an optical system provided between the scanning mechanism (scanner) 31 and the imaging lens 23. The scanning optical system 32 is an optical system that allows the focal position of the scanning optical system 32 to be positioned on an imaging surface 13 (also called a primary image surface) conjugate with the sample SA (scanning surface for the sample SA).

The collective optical system 4 includes: the objective lens 24 and the imaging lens 23, which constitute the microscope optical system 25; a total reflection mirror 41; and a collective lens 42. The objective lens 24 receives fluorescence generated at the sample SA, and converts it into parallel light. The imaging lens 23 once collects the fluorescence (parallel light) emitted from the objective lens 24, on the imaging surface 13 (primary image surface), thus focusing it thereon. Accordingly, the fluorescence from the sample SA that has passed through the objective lens 24 and the imaging lens 23 is once collected on the imaging surface 13, passes through the scanning device 3 and the dichroic mirror 22, and reaches the total reflection mirror 41. The total reflection mirror 41 and the collective lens 42 are arranged above the dichroic mirror 22 in the microscope housing 12. The total reflection mirror 41 reflects the fluorescence that has been from the sample SA and passed through the objective lens 24 and the imaging lens 23. The collective lens 42 focuses the fluorescence reflected by the total reflection mirror 41, on a light shielding plate 52 that has a pinhole 51 (aperture).

The optical detection device 5 includes: the light shielding plate 52, which has the pinhole 51; an optical fiber 53; and a detection unit 55. The optical fiber 53 is connected to the microscope housing 12 and the detection unit 55 using connectors C1 and C2. Light (fluorescence) having passed through the pinhole 51 enters the optical fiber 53. The detection unit 55 detects the light (fluorescence) that has passed through the pinhole 51 and the optical fiber 53. A processing unit 57 is electrically connected to the detection unit 55 via the cable 56. Image processing (of the sample SA) based on a detection signal detected at the detection unit 55 is performed by the processing unit 57, and an observation image of the sample SA obtained by the image processing by the processing unit 57 is displayed on a monitor, which is not shown.

Note that it is configured such that the laser light from the scanning device 3 is once focused on the imaging surface 13 (primary image surface), and is focused again on the sample SA by the imaging lens 23 and the objective lens 24 of the microscope optical system 25. That is, the scanning surface for the sample SA, the imaging surface 13, and the pinhole 51 have a relationship conjugate to each other. Accordingly, by configuring the imaging lens 23 and the objective lens 24 to focus the light on the sample SA, fluorescence generated on the scanning surface for the sample SA in the light from the sample SA (fluorescence) is allowed to pass through the pinhole 51.

As an example of the microscope device according to the present embodiment, the confocal fluorescence microscope 1 has been described, but there is no limitation to this. For example, the microscope device according to the present embodiment may be a multiphoton excitation microscope, a super-resolution microscope or the like. The confocal fluorescence microscope 1 may be an upright microscope, or an inverted microscope.

As the objective lens 24 of the microscope optical system 25 provided in such a confocal fluorescence microscope 1 (microscope device), an after-mentioned microscope objective lens OL can be used. As the imaging lens 23 of the microscope optical system 25 provided in such a confocal fluorescence microscope 1, an after-mentioned imaging lens IL can be used. First, the microscope objective lens OL according to a first embodiment is described.

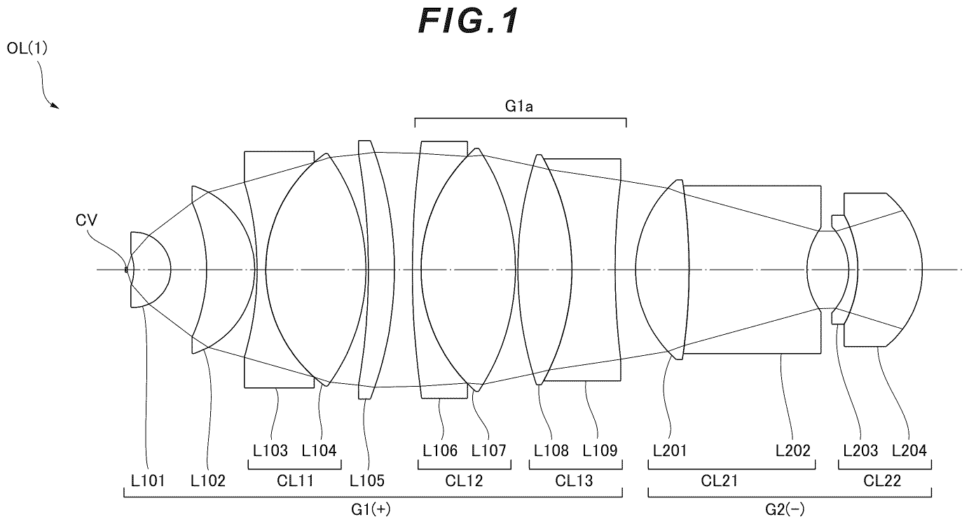

As an example of the microscope objective lens OL according to the first embodiment, a microscope objective lens OL(1) shown in FIG. 1 includes: a first lens group G1, and a second lens group G2 having a negative refractive power which are disposed in order from an object along the optical axis. The second lens group G2 includes a cemented meniscus lens CL21 having a concave surface facing the image, and a meniscus lens component (CL22) having a concave surface facing the object which are disposed in order from the object along the optical axis. Note that in each embodiment, each lens component indicates a single lens or a cemented lens. The meniscus lens component may be a cemented meniscus lens that includes a plurality of lenses cemented to each other. The meniscus lens component is not limited to the cemented meniscus lens, and may be a meniscus lens that includes a single lens.

With the configuration described above, the first lens group G1 includes a specified positive meniscus lens that satisfies the following conditional expressions (1) to (3).

$$0 < θ gFA + 0.0015 \times vdA - 0.6395 , \qquad ( 1 )$$

$$1.6 < ndA < 1.85 , and \qquad ( 2 )$$

$$39.5 < vdA < 75. , \qquad ( 3 )$$

where ndA: a refractive index of the specified positive meniscus lens with respect to d-line,
vdA: an Abbe number of the specified positive meniscus lens, and
θgFA: a partial dispersion ratio of the specified positive meniscus lens, defined by the following expression when it is assumed that a refractive index of the specified positive meniscus lens with respect to g-line is ngA, a refractive index of the specified positive meniscus lens with respect to F-line is nFA, and a refractive index of the specified positive meniscus lens with respect to C-line is nCA,

$$θ gFA = ( ngA - nFA ) / ( nFA - nCA ) .$$

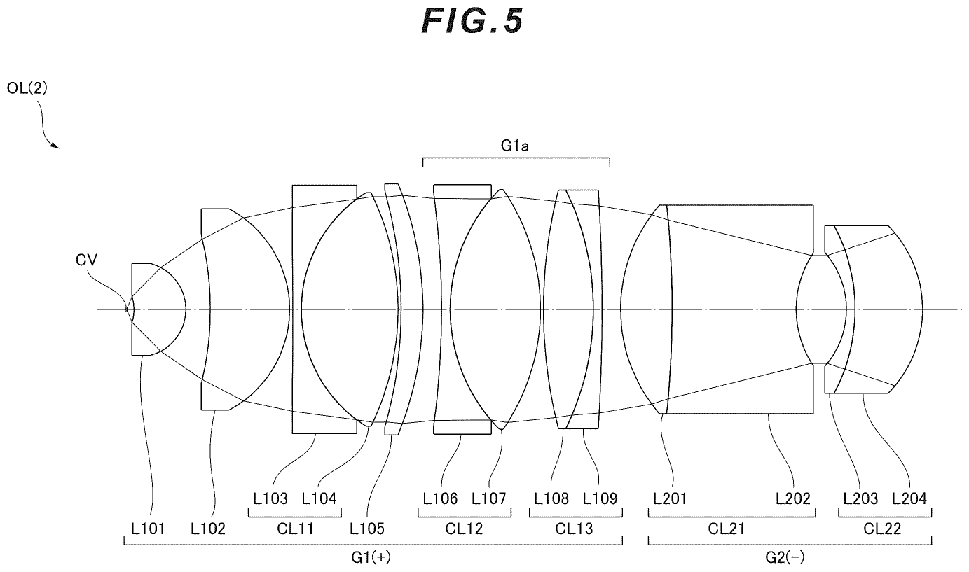

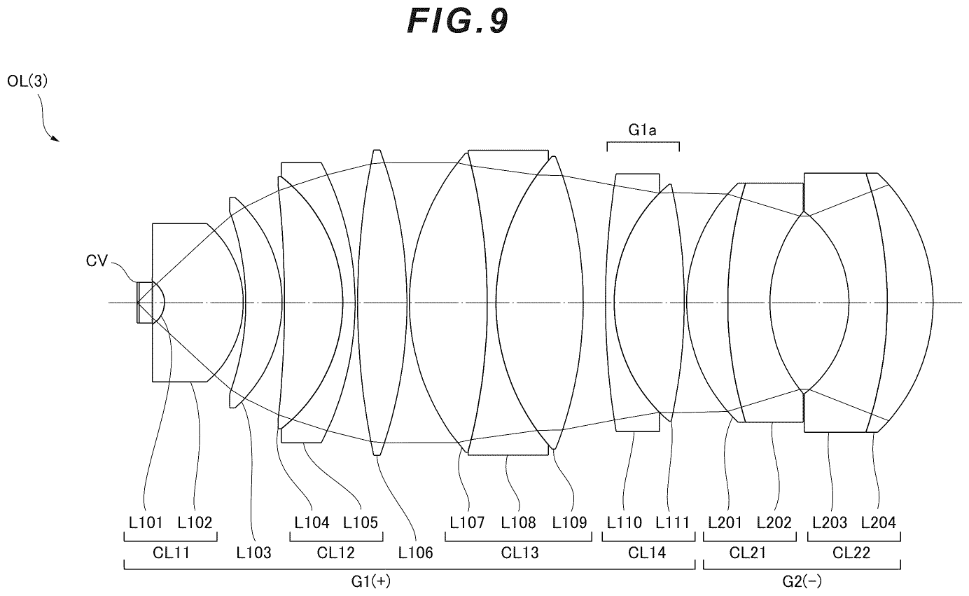

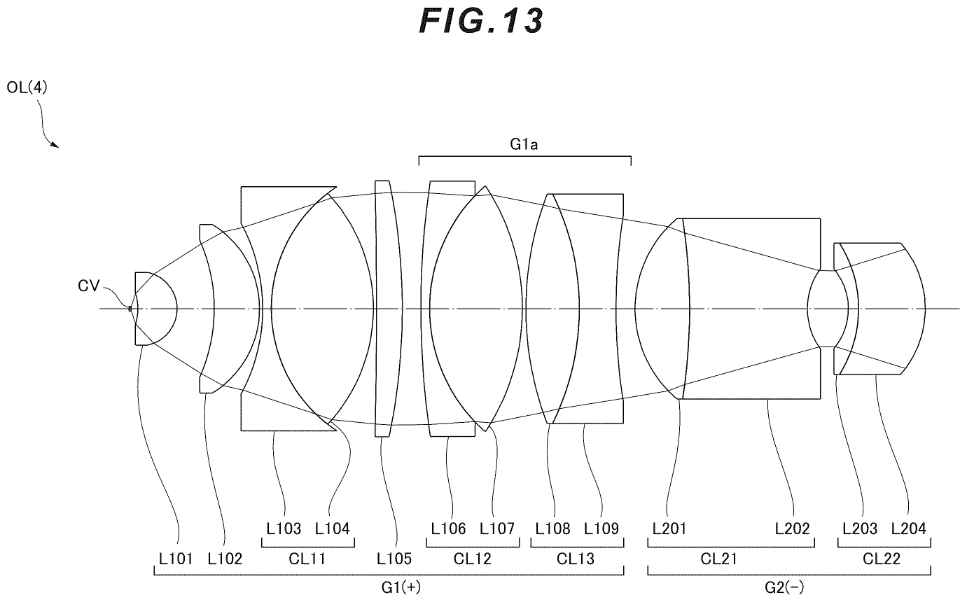

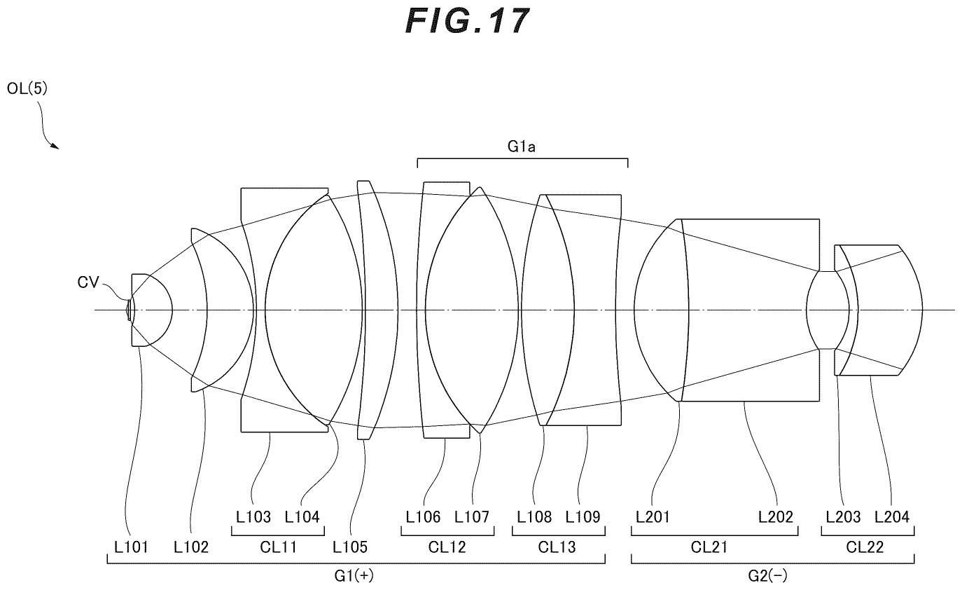

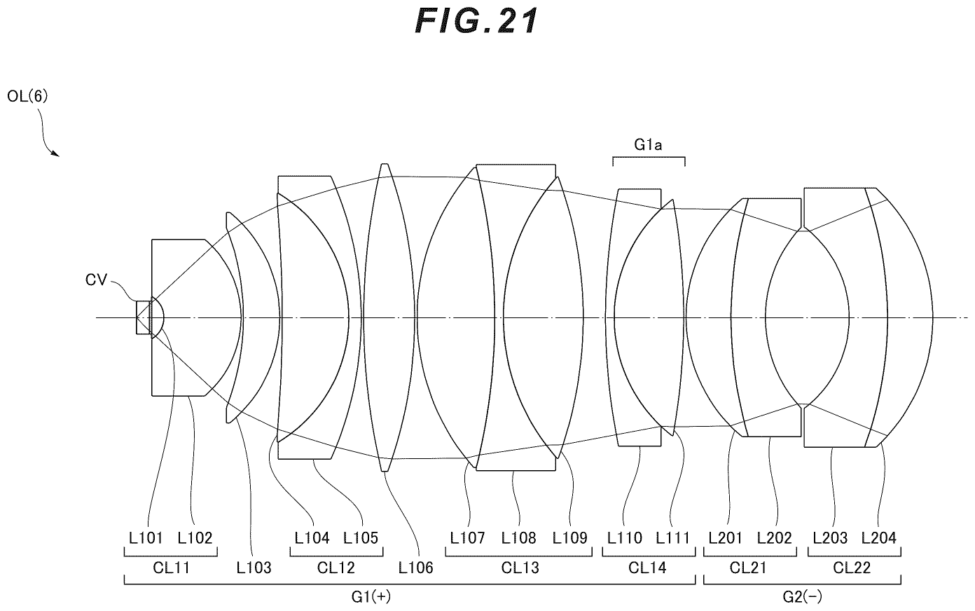

According to the first embodiment, the microscope objective lens with chromatic aberration and other aberrations favorably corrected, and the microscope optical system and the microscope device that include this microscope objective lens can be achieved. The microscope objective lens OL according to the first embodiment may be a microscope objective lens OL(2) shown in FIG. 5, a microscope objective lens OL(3) shown in FIG. 9, a microscope objective lens OL(4) shown in FIG. 13, a microscope objective lens OL(5) shown in FIG. 17, or a microscope objective lens OL(6) shown in FIG. 21.

The conditional expression (1) defines an appropriate relationship between the Abbe number and the partial dispersion ratio of the specified positive meniscus lens of the first lens group G1. By satisfying the conditional expression (1), the longitudinal chromatic aberration and the chromatic aberration of magnification can be favorably corrected. Note that the specified positive meniscus lens that satisfies the conditional expressions (1) to (3) and the like is formed using, for example, an optical glass disclosed in WO2021/024366.

If the corresponding value of the conditional expression (1) falls below the lower limit value, it is difficult to correct the secondary spectrum of the longitudinal chromatic aberration and the secondary spectrum of the chromatic aberration of magnification. By setting the lower limit value of the conditional expression (1) to 0.001, 0.002, and further to 0.003, the advantageous effects of the present embodiment can be further secured. The upper limit value of the conditional expression (1) may be set to 0.1, and further set to be less than 0.05.

The conditional expression (2) defines an appropriate range of the refractive index of the specified positive meniscus lens of the first lens group G1. By satisfying the conditional expression (2), the off-axis coma aberration can be favorably corrected while correcting the curvature of field.

If the corresponding value of the conditional expression (2) exceeds the upper limit value, the refractive index of the specified positive meniscus lens becomes high, which makes it difficult to reduce the Petzval sum, and makes it difficult to correct the curvature of field. By setting the upper limit value of the conditional expression (2) to 1.80, 1.75, and further to 1.70, the advantageous effects of the present embodiment can be further secured.

If the corresponding value of the conditional expression (2) falls below the lower limit value, the refractive index of the specified positive meniscus lens becomes low, which makes it difficult to correct the off-axis coma aberration. By setting the lower limit value of the conditional expression (2) to 1.61, and further to 1.62, the advantageous effects of the present embodiment can be further secured.

The conditional expression (3) defines an appropriate range of the Abbe number of the specified positive meniscus lens of the first lens group G1. By satisfying the conditional expression (3), the primary spectrum of the longitudinal chromatic aberration and the primary spectrum of the chromatic aberration of magnification can be favorably corrected.

If the corresponding value of the conditional expression (3) exceeds the upper limit value, the specified positive meniscus lens is required to be made of an optical glass having a low refractive index, which makes it difficult to correct the off-axis coma aberration. By setting the upper limit value of the conditional expression (3) to 70.00, 68.00, 65.00, and further to 63.00, the advantageous effects of the present embodiment can be further secured.

If the corresponding value of the conditional expression (3) falls below the lower limit value, the dispersion of the specified positive meniscus lens becomes high, which makes it difficult to correct the primary spectrum of the longitudinal chromatic aberration and the primary spectrum of the chromatic aberration of magnification. By setting the lower limit value of the conditional expression (3) to 40.00, 42.50, and further to 45.00, the advantageous effects of the present embodiment can be further secured.

Next, a microscope objective lens according to a second embodiment is described. Since the microscope objective lens according to the second embodiment has a configuration similar to that of the microscope objective lens OL according to the first embodiment, the same symbols as those of the first embodiment are assigned and the description is made. As an example of the microscope objective lens OL according to the second embodiment, a microscope objective lens OL(1) shown in FIG. 1 includes: a first lens group G1, and a second lens group G2 having a negative refractive power which are disposed in order from an object along the optical axis. The second lens group G2 includes a cemented meniscus lens CL21 having a concave surface facing the image, and a meniscus lens component (CL22) having a concave surface facing the object which are disposed in order from the object along the optical axis.

With the configuration described above, the first lens group G1 includes a specified positive meniscus lens that satisfies the following conditional expression (4), conditional expression (2), and conditional expression (3).

$$0 < θ gFA + 0.0016 \times vdA - 0.646 \qquad ( 4 )$$

$$1.6 < ndA < 1.85 , and \qquad ( 2 )$$

$$39.5 < vdA < 75. , \qquad ( 3 )$$

where ndA: a refractive index of the specified positive meniscus lens with respect to d-line,
vdA: an Abbe number of the specified positive meniscus lens, and
θgFA: a partial dispersion ratio of the specified positive meniscus lens, defined by the following expression when it is assumed that a refractive index of the specified positive meniscus lens with respect to g-line is ngA, a refractive index of the specified positive meniscus lens with respect to F-line is nFA, and a refractive index of the specified positive meniscus lens with respect to C-line is nCA,

$$θ gFA = ( ngA - nFA ) / ( nFA - nCA ) .$$

According to the second embodiment, the microscope objective lens with chromatic aberration and other aberrations favorably corrected, and the microscope optical system and the microscope device that include this microscope objective lens can be achieved. The microscope objective lens OL according to the second embodiment may be the microscope objective lens OL(2) shown in FIG. 5, the microscope objective lens OL(3) shown in FIG. 9, the microscope objective lens OL(4) shown in FIG. 13, the microscope objective lens OL(5) shown in FIG. 17, or the microscope objective lens OL(6) shown in FIG. 21.

The conditional expression (4) defines an appropriate relationship between the Abbe number and the partial dispersion ratio of the specified positive meniscus lens of the first lens group G1. By satisfying the conditional expression (4), the longitudinal chromatic aberration and the chromatic aberration of magnification can be favorably corrected. Note that the specified positive meniscus lens that satisfies the conditional expression (4), conditional expression (2), conditional expression (3) and the like is formed using, for example, an optical glass disclosed in WO2021/024366.

If the corresponding value of the conditional expression (4) falls below the lower limit value, it is difficult to correct the secondary spectrum of the longitudinal chromatic aberration and the secondary spectrum of the chromatic aberration of magnification. By setting the lower limit value of the conditional expression (4) to 0.0002, 0.0004, 0.001, 0.002, and further to 0.0025, the advantageous effects of the present embodiment can be further secured. The upper limit value of the conditional expression (4) may be set to 0.1, and further set to be less than 0.05.

The conditional expression (2) defines an appropriate range of the refractive index of the specified positive meniscus lens of the first lens group G1 as described above. By satisfying the conditional expression (2), the off-axis coma aberration can be favorably corrected while correcting the curvature of field. By setting the upper limit value of the conditional expression (2) to 1.80, 1.75, and further to 1.70, the advantageous effects of the present embodiment can be further secured. By setting the lower limit value of the conditional expression (2) to 1.61, and further to 1.62, the advantageous effects of the present embodiment can be further secured.

The conditional expression (3) defines an appropriate range of the Abbe number of the specified positive meniscus lens of the first lens group G1 as described above. By satisfying the conditional expression (3), the primary spectrum of the longitudinal chromatic aberration and the primary spectrum of the chromatic aberration of magnification can be favorably corrected. By setting the upper limit value of the conditional expression (3) to 70.00, 68.00, 65.00, and further to 63.00, the advantageous effects of the present embodiment can be further secured. By setting the lower limit value of the conditional expression (3) to 40.00, 42.50, and further to 45.00, the advantageous effects of the present embodiment can be further secured.

In the microscope objective lenses OL according to the first embodiment and the second embodiment, the specified positive meniscus lens may be a positive meniscus lens that satisfies the following conditional expression (5).

$$- 10 < GAR 1 / DGA 1 < 1 \qquad ( 5 )$$

where GAR1: a curvature radius of an object-side lens surface of the positive meniscus lens, and
DGA1: a distance from the object-side lens surface of the positive meniscus lens to the object on the optical axis.

The conditional expression (5) defines an appropriate relationship between the curvature radius of the object-side lens surface of the positive meniscus lens corresponding to the specified positive meniscus lens, and the distance from the object-side lens surface of the positive meniscus lens to the object on the optical axis. Note that in each embodiment, the curvature radius of the lens surface has a positive value in a case of a lens surface that is convex toward the object. By satisfying the conditional expression (5), the off-axis coma aberration can be favorably corrected while correcting the curvature of field.

If the corresponding value of the conditional expression (5) is out of the range, the curvature of the object-side lens surface of the positive meniscus lens becomes small, which makes it difficult to correct the off-axis coma aberration while correcting the curvature of field. By setting the upper limit value of the conditional expression (5) to 0.5, and further to 0.2, the advantageous effects of each embodiment can be further secured. By setting the lower limit value of the conditional expression (5) to −8, and further to −7, the advantageous effects of each embodiment can be further secured.

In the microscope objective lenses OL according to the first embodiment and the second embodiment, the specified positive meniscus lens satisfies the following conditional expression (6).

$$- 10 < GAR 2 / DGA 2 < 0 \qquad ( 6 )$$

where GAR2: a curvature radius of an image-side lens surface of the positive meniscus lens, and
DGA2: a distance from the image-side lens surface of the positive meniscus lens to the object on the optical axis.

The conditional expression (6) defines an appropriate relationship between the curvature radius of the image-side lens surface of the positive meniscus lens corresponding to the specified positive meniscus lens, and the distance from the image-side lens surface of the positive meniscus lens to the object on the optical axis. By satisfying the conditional expression (6), the off-axis coma aberration can be favorably corrected while correcting the curvature of field.

If the corresponding value of the conditional expression (6) is out of the range, the curvature of the image-side lens surface of the positive meniscus lens becomes small, which makes it difficult to correct the off-axis coma aberration while correcting the curvature of field. By setting the upper limit value of the conditional expression (6) to −0.2, and further to −0.5, the advantageous effects of each embodiment can be further secured. By setting the lower limit value of the conditional expression (6) to −5, and further to −2, the advantageous effects of each embodiment can be further secured.

In the microscope objective lenses OL according to the first embodiment and the second embodiment, the specified positive meniscus lens satisfies the following conditional expression (7).

$$- 0.3 < ( GAR 2 - GAR 1 + GAL ) / TL < 0.3 \qquad ( 7 )$$

where GAR1: a curvature radius of an object-side lens surface of the positive meniscus lens,
GAR2: a curvature radius of an image-side lens surface of the positive meniscus lens,
GAL: a length of the positive meniscus lens on the optical axis, and
TL: a distance of the microscope objective lens OL from a lens surface closest to the object to a lens surface closest to the image on the optical axis.

In each embodiment, the difference between the curvature radius of the image-side lens surface and the curvature radius of the object-side lens surface of the meniscus lens with the length of the meniscus lens on the optical axis added indicates the difference in the spherical centers between the image-side lens surface and the object-side lens surface of the meniscus lens. The difference in the spherical centers between the image-side lens surface and the object-side lens surface of the meniscus lens can also called the difference between the position of the center of curvature of the image-side lens surface and the position of the center of curvature of the object-side lens surface of the meniscus lens. The conditional expression (7) defines an appropriate relationship between the difference in the spherical centers between the image-side lens surface and the object-side lens surface of the positive meniscus lens corresponding to the specified positive meniscus lens, and the distance on the optical axis from the lens surface closest to the object to the lens surface closest to the image of the microscope objective lens OL. By satisfying the conditional expression (7), the sine condition can be satisfied, and the off-axis coma aberration can be favorably corrected.

If the corresponding value of the conditional expression (7) is out of the range, it is difficult to correct the off-axis coma aberration. By setting the upper limit value of the conditional expression (7) to 0.27, 0.25, 0.20, 0.19, 0.15, 0.10, and further to 0.08, the advantageous effects of each embodiment can be further secured. By setting the lower limit value of the conditional expression (7) to −0.21, −0.20, −0.15, −0.10, and further to 0.00, the advantageous effects of each embodiment can be further secured.

In the microscope objective lenses OL according to the first embodiment and the second embodiment, the positive meniscus lens may be disposed closest to the object in the first lens group G1. By disposing the positive meniscus lens, i.e., the specified positive meniscus lens, closest to the object in the first lens group G1, the secondary spectrum of the longitudinal chromatic aberration and the secondary spectrum of the chromatic aberration of magnification can be favorably corrected. In a microscope objective lens with a gap with the cover glass filled with air, the disposition of the positive meniscus lens (specified positive meniscus lens) closest to the object in the first lens group G1 makes the refractive index difference on the object-side lens surface of the positive meniscus lens sufficiently large to satisfy the conditional expression (2), thereby allowing the Petzval sum to be effectively reduced.

In the microscope objective lenses OL according to the first embodiment and the second embodiment, the first lens group G1 may include a partial group G1a that is movable along the optical axis. Accordingly, the partial group G1a of the first lens group G1 functions as what is called a correction collar, and can favorably correct the spherical aberration and the longitudinal chromatic aberration that vary depending on the thickness of the cover glass CV.

In the microscope objective lenses OL according to the first embodiment and the second embodiment, the first lens group G1 includes an image-side lens that has a positive refractive power and is disposed closer to the image than the positive meniscus lens described above, and the image-side lens may satisfy the following conditional expression (8) and conditional expression (9).

$$0 < θ gFB 1 + 0.0015 \times vdB 1 - 0.6395 \qquad ( 8 )$$

$$vdB 1 < 40. \qquad ( 9 )$$

where vdB1: an Abbe number of the image-side lens,
θgFB1: a partial dispersion ratio of the image-side lens, defined by the following expression when it is assumed that a refractive index of the image-side lens with respect to g-line is ngB1, a refractive index of the image-side lens with respect to F-line is nFB1, and a refractive index of the image-side lens with respect to C-line is nCB1,

$$θ gFB 1 = ( ngB 1 - nFB 1 ) / ( nFB 1 - nCB 1 ) .$$

The conditional expression (8) defines an appropriate relationship between the Abbe number and the partial dispersion ratio of the image-side lens of the first lens group G1. The conditional expression (9) defines an appropriate range of the Abbe number of the image-side lens of the first lens group G1. In addition to the positive meniscus lens (specified positive meniscus lens) disposed closest to the object in the first lens group G1, the image-side lens that satisfies the conditional expression (8) and the conditional expression (9) is provided, which can favorably correct the secondary spectrum of the longitudinal chromatic aberration in addition to the primary spectrum of the longitudinal chromatic aberration. Note that the image-side lens that satisfies the conditional expression (8) and the conditional expression (9) is formed using, for example, an optical glass disclosed in WO2019/082419.

If the corresponding value of the conditional expression (8) falls below the lower limit value, it is difficult to correct the secondary spectrum of the longitudinal chromatic aberration. By setting the lower limit value of the conditional expression (8) to 0.001, 0.002, and further to 0.003, the advantageous effects of each embodiment can be further secured. The upper limit value of the conditional expression (8) may be set to 0.1, and further set to be less than 0.05.

If the corresponding value of the conditional expression (9) exceeds the upper limit value, it is difficult to correct the secondary spectrum of the longitudinal chromatic aberration. By setting the upper limit value of the conditional expression (9) to 35.00, further to 33.00, the advantageous effects of each embodiment can be further secured.

In the microscope objective lenses OL according to the first embodiment and the second embodiment, the first lens group G1 may include a lens component that is disposed closest to the object in the first lens group G1 and has a flat surface facing the object, and the positive meniscus lens may be disposed side by side with, and closer to the image than, the lens component. By disposing the positive meniscus lens, i.e., the specified positive meniscus lens, side by side with, and closer to the image than, the lens component closest to the object in the first lens group G1, the secondary spectrum of the longitudinal chromatic aberration and the secondary spectrum of the chromatic aberration of magnification can be favorably corrected. In a type of microscope objective lens with the gap with a cover glass filled with immersion liquid, the disposition of the positive meniscus lens (specified positive meniscus lens) side by side with, and closer to the image than, the lens component closest to the object in the first lens group G1 can effectively correct the longitudinal chromatic aberration and the chromatic aberration of magnification. As described above, in each embodiment, each lens component indicates a single lens or a cemented lens. The lens component closest to the object in the first lens group G1 may be a cemented lens that includes a plano-convex-shaped positive lens having a flat surface facing the object. The lens component closest to the object in the first lens group G1 is not limited to the cemented lens, and may be a single lens.

In the microscope objective lenses OL according to the first embodiment and the second embodiment, the second lens group G2 may be movable along the optical axis, and the first lens group G1 may include a partial group that is movable together with the second lens group G2 along the optical axis. Accordingly, the partial group of the first lens group G1, and the second lens group G2 function as what is called a correction collar, and can favorably correct the spherical aberration and the longitudinal chromatic aberration that vary depending on the thickness of the cover glass Cv.

In the microscope objective lenses OL according to the first embodiment and the second embodiment, the first lens group G1 includes an image-side lens that has a positive refractive power and is disposed closer to the image than the positive meniscus lens described above, and the image-side lens may satisfy the following conditional expressions (10) to (12).

$$0 < θ gFB 2 + 0.0015 \times vdB 2 - 0.6395 , \qquad ( 10 )$$

$$1.6 < ndB 2 < 1.85 , and \qquad ( 11 )$$

$$39.5 < vdB 2 < 75. , \qquad ( 12 )$$

where ndB2: a refractive index of the image-side lens with respect to d-line,
vdB2: an Abbe number of the image-side lens, and
θgFB2: a partial dispersion ratio of the image-side lens, defined by the following expression when it is assumed that a refractive index of the image-side lens with respect to g-line is ngB2, a refractive index of the image-side lens with respect to F-line is nFB2, and a refractive index of the image-side lens with respect to C-line is nCB2,

$$θ gFB 2 = ( ngB 2 - nFB 2 ) / ( nFB 2 - nCB 2 ) .$$

The conditional expression (10) defines an appropriate relationship between the Abbe number and the partial dispersion ratio of the image-side lens of the first lens group G1. The conditional expression (11) defines an appropriate range of the refractive index of the image-side lens of the first lens group G1. The conditional expression (12) defines an appropriate range of the Abbe number of the image-side lens of the first lens group G1. By disposing the positive meniscus lens (specified positive meniscus lens) side by side with, and closer to the image than, the lens component closest to the object in the first lens group G1, and further disposing the image-side lens satisfying the conditional expressions (10) to (12), the secondary spectrum of the longitudinal chromatic aberration and the secondary spectrum of the chromatic aberration of magnification can be favorably corrected. In a type of microscope objective lens with the gap with a cover glass filled with immersion liquid, in addition to the disposition of the positive meniscus lens (specified positive meniscus lens) side by side with, and closer to the image than, the lens component closest to the object in the first lens group G1, the disposition of the image-side lens satisfying the conditional expressions (10) to (12) can effectively correct the longitudinal chromatic aberration and the chromatic aberration of magnification. Note that the image-side lens that satisfies the conditional expressions (10) to (12) is formed using, for example, an optical glass disclosed in WO2021/024366.

If the corresponding value of the conditional expression (10) falls below the lower limit value, it is difficult to correct the secondary spectrum of the longitudinal chromatic aberration and the secondary spectrum of the chromatic aberration of magnification. By setting the lower limit value of the conditional expression (10) to 0.001, 0.002, and further to 0.003, the advantageous effects of each embodiment can be further secured. The upper limit value of the conditional expression (10) may be set to 0.1, and further set to be less than 0.05.

If the corresponding value of the conditional expression (11) is out of the range, it is difficult to effectively correct the longitudinal chromatic aberration and the chromatic aberration of magnification. By setting the upper limit value of the conditional expression (11) to 1.80, 1.75, and further to 1.70, the advantageous effects of each embodiment can be further secured. By setting the lower limit value of the conditional expression (11) to 1.61, and further to 1.62, the advantageous effects of each embodiment can be further secured.

If the corresponding value of the conditional expression (12) is out of the range, it is difficult to effectively correct the longitudinal chromatic aberration and the chromatic aberration of magnification. By setting the upper limit value of the conditional expression (12) to 70.00, 68.00, 65.00, and further to 63.00, the advantageous effects of each embodiment can be further secured. By setting the lower limit value of the conditional expression (12) to 40.00, 42.50, and further to 45.00, the advantageous effects of each embodiment can be further secured.

In the microscope objective lenses OL according to the first embodiment and the second embodiment, the first lens group G1 includes an image-side lens that has a positive refractive power and is disposed closer to the image than the positive meniscus lens described above, and the image-side lens may satisfy the following conditional expression (13), conditional expression (11), and conditional expression (12).

$$0 < θ gFB 2 + 0.0016 \times vdB 2 - 0.646 , \qquad ( 13 )$$

$$1.6 < ndB 2 < 1.85 , and \qquad ( 11 )$$

$$39.5 < vdB 2 < 75. , \qquad ( 12 )$$

where ndB2: a refractive index of the image-side lens with respect to d-line,
vdB2: an Abbe number of the image-side lens, and
θgFB2: a partial dispersion ratio of the image-side lens, defined by the following expression when it is assumed that a refractive index of the image-side lens with respect to g-line is ngB2, a refractive index of the image-side lens with respect to F-line is nFB2, and a refractive index of the image-side lens with respect to C-line is nCB2,

$$θ gFB 2 = ( ngB 2 - nFB 2 ) / ( nFB 2 - nCB 2 ) .$$

The conditional expression (13) defines an appropriate relationship between the Abbe number and the partial dispersion ratio of the image-side lens of the first lens group G1. The conditional expression (11) defines an appropriate range of the refractive index of the image-side lens of the first lens group G1. The conditional expression (12) defines an appropriate range of the Abbe number of the image-side lens of the first lens group G1. By disposing the positive meniscus lens (specified positive meniscus lens) side by side with, and closer to the image than, the lens component closest to the object in the first lens group G1, and further disposing the image-side lens satisfying the conditional expression (13), the conditional expression (11), and the conditional expression (12), the secondary spectrum of the longitudinal chromatic aberration and the secondary spectrum of the chromatic aberration of magnification can be favorably corrected. In a type of microscope objective lens with the gap with a cover glass filled with immersion liquid, in addition to the disposition of the positive meniscus lens (specified positive meniscus lens) side by side with, and closer to the image than, the lens component closest to the object in the first lens group G1, the disposition of the image-side lens satisfying the conditional expression (13), the conditional expression (11), and the conditional expression (12) can effectively correct the longitudinal chromatic aberration and the chromatic aberration of magnification. Note that the image-side lens that satisfies the conditional expression (13), the conditional expression (11), and the conditional expression (12) is formed using, for example, an optical glass disclosed in WO2021/024366.

If the corresponding value of the conditional expression (13) falls below the lower limit value, it is difficult to correct the secondary spectrum of the longitudinal chromatic aberration and the secondary spectrum of the chromatic aberration of magnification. By setting the lower limit value of the conditional expression (13) to 0.0002, 0.0004, 0.001, 0.002, and further to 0.0025, the advantageous effects of each embodiment can be further secured. The upper limit value of the conditional expression (13) may be set to 0.1, and further set to be less than 0.05.

If the corresponding value of the conditional expression (11) is out of the range, it is difficult to effectively correct the longitudinal chromatic aberration and the chromatic aberration of magnification. By setting the upper limit value of the conditional expression (11) to 1.80, 1.75, and further to 1.70, the advantageous effects of each embodiment can be further secured. By setting the lower limit value of the conditional expression (11) to 1.61, and further to 1.62, the advantageous effects of each embodiment can be further secured.

If the corresponding value of the conditional expression (12) is out of the range, it is difficult to effectively correct the longitudinal chromatic aberration and the chromatic aberration of magnification. By setting the upper limit value of the conditional expression (12) to 70.00, 68.00, 65.00, and further to 63.00, the advantageous effects of each embodiment can be further secured. By setting the lower limit value of the conditional expression (12) to 40.00, 42.50, and further to 45.00, the advantageous effects of each embodiment can be further secured.

### EXAMPLES

Examples of the microscope objective lenses OL according to the embodiments are described below with reference to the drawings. FIGS. 1, 5, 9, 13, 17, and 21 are optical path diagrams showing the configurations of microscope objective lenses OL {OL(1) to OL(6)} according to First to Sixth Example. In these FIGS. 1, 5, 9, 13, 17, and 21, each lens group is represented by a combination of a symbol G and a numeral (or an alphabetical letter), and each lens is represented by a combination of a symbol L and a numeral (or an alphabetical letter). In this case, to prevent the number and types of symbols and numerals from increasing and causing complication, each lens or the like is represented using a combination of a symbol and a numeral independently with respect to each Example. Accordingly, even when the same combination of a symbol and a numeral is used between Examples, it does not indicate the same configuration.

While Tables 1 to 6 are shown below, among them, Table 1 is a table showing data items in First Example, Table 2 is a table showing those in Second Example, Table 3 is a table showing those in Third Example, Table 4 is a table showing those in Fourth Example, Table 5 is a table showing those in Fifth Example, and Table 6 is a table showing those in Sixth Example. In each Example, d-line (wavelength λ=587.6 nm), C-line (wavelength λ=656.3 nm), and F-line (wavelength λ=486.1 nm) are selected for calculation targets of aberration characteristics.

In the table of [General Data], β indicates the magnification of the microscope objective lens. f indicates the focal length of the microscope objective lens. ϕ indicates the pupil diameter of the microscope objective lens. NA indicates the numerical aperture of the microscope objective lens. TL indicates an entire length of the microscope objective lens (the distance from the lens surface closest to the object to a lens surface closest to the image on the optical axis in the microscope objective lens).

In the table of [Lens Data], the surface number indicates the order of lens surface from the object, R indicates the curvature radius corresponding to each surface number (a positive value is assumed in the case of a lens surface that is convex facing the object), D indicates the lens thickness or the air distance on the optical axis corresponding to each surface number, nd indicates the refractive index of an optical material with respect to d-line (wavelength λ=587.6 nm) corresponding to each surface number, vd indicates the Abbe number of an optical material with respect to d-line corresponding to each surface number, and θgF indicates the partial dispersion ratio of the material of an optical member corresponding to each surface number. “∞” of the curvature radius indicates a flat surface or an aperture. Description of air refractive index nd=1.00000 is omitted.

It is assumed that the refractive index of the material of the optical member with respect to g-line (wavelength λ=435.8 nm) is ng, the refractive index of the material of the optical member with respect to F-line (wavelength λ=486.1 nm) is nF, and the refractive index of the material of the optical member with respect to C-line (wavelength λ=656.3 nm) is nC. In this case, the partial dispersion ratio θgF of the material of the optical member is defined by the following expression (A).

$$θ gF = ( ng - nF ) / ( nF - nC ) \qquad ( A )$$

The table of [Variable Distance Data] indicates the surface distance at the surface number i on the table of [Lens Data] where the surface distance is (Di). The table of [Variable Distance Data] shows the surface distance depending on the thickness of the cover glass. In the table of [Variable Distance Data] (and the table of [Lens Data]), CG indicates the thickness of the cover glass. DO indicates the distance between the cover glass and the lens surface closest to the object of the microscope objective lens.

The table of [Lens Group Data] shows the first surface (surface closest to the object) and the focal length of each lens group.

Hereinafter, while with respect to all the data items, “mm” is used for the listed focal length f, curvature radius R, surface distance D, other length and the like unless otherwise noted, there is no limitation to this because similar optical performances can be achieved even with proportional expansion or proportional contraction of the optical system.

The description of the tables so far is common to all Examples, and redundant description below is omitted.

### First Example

First Example is described with reference to FIGS. 1 to 4 and Table 1. FIG. 1 is a sectional view showing the configuration of a microscope objective lens according to First Example. The microscope objective lens OL(1) according to First Example includes a first lens group G1 having a positive refractive power, and a second lens group G2 having a negative refractive power which are disposed in order from the object along the optical axis. The gap between a distal end of the microscope objective lens OL(1) according to First Example and the cover glass CV that covers an object is filled with air. Note that the refractive index of the cover glass CV with respect to d-line (wavelength λ=587.6 nm) is assumed as 1.5244.

The first lens group G1 includes, in order from the object along the optical axis: a positive meniscus lens L101 having a concave surface facing the object; a positive meniscus lens L102 having a concave surface facing the object; a first cemented lens CL11 that includes a biconcave negative lens L103 and a biconvex positive lens L104 cemented to each other; a positive meniscus lens L105 having a concave surface facing the object; a second cemented lens CL12 that includes a negative meniscus lens L106 having a convex surface facing the object, and a biconvex positive lens L107 cemented to each other; and a third cemented lens CL13 that includes a biconvex positive lens L108 and a biconcave negative lens L109 cemented to each other. The positive meniscus lens L101 disposed closest to the object in the first lens group G1 corresponds to the specified positive meniscus lens described above. The positive meniscus lens L105 of the first lens group G1 corresponds to the image-side lens that satisfies the conditional expression (8) and conditional expression (9) described above.

The second lens group G2 includes, in order from the object along the optical axis: a first cemented meniscus lens CL21 that includes a biconvex positive lens L201 and a biconcave negative lens L202 cemented to each other; and a second cemented meniscus lens CL22 that includes a negative meniscus lens L203 having a concave surface facing the object, and a positive meniscus lens L204 having a concave surface facing the object, the lenses being cemented to each other. The first cemented meniscus lens CL21 is a cemented meniscus lens having a concave surface facing the image. The second cemented meniscus lens CL22 is a cemented meniscus lens having a concave surface facing the object (meniscus component).

Note that it is configured to allow the second cemented lens CL12 and the third cemented lens CL13 of the first lens group G1 to move along the optical axis depending on the thickness of the cover glass CV. The second cemented lens CL12 and the third cemented lens CL13 of the first lens group G1 constitute the partial group G1a described above.

Table 1 below lists the values of data of the microscope objective lens according to First Example. Note that the first surface is the object surface.

TABLE 1
[General Data]
β = 40.0 times
f = 5.000
NA = 0.950
φ = 9.500
TL = 63.550
[Lens Data]

| Surface | | | | | |
|---|---|---|---|---|---|
| Number | R | D | nd | νd | θgF |
| 1 | ∞ | 0.000 | | | |
| 2 | ∞ | 0.170 | 1.5244 | 54.30 | |
| | | (CG) | | | |
| 3 | ∞ | 0.540 | | | |
| | | (D0) | | | |
| 4 | −3.558 | 2.971 | 1.6285 | 59.17 | 0.5557 |
| 5 | −3.040 | 2.893 | | | |
| 6 | −13.104 | 3.869 | 1.4978 | 82.57 | |
| 7 | −7.093 | 0.200 | | | |
| 8 | −24.625 | 0.700 | 1.6127 | 44.46 | |
| 9 | 11.565 | 8.066 | 1.5932 | 67.90 | |
| 10 | −15.703 | 0.200 | | | |
| 11 | −54.760 | 2.097 | 1.7558 | 24.71 | 0.629 |
| 12 | −28.966 | (D12) | | | |
| 13 | 72.626 | 0.700 | 1.7340 | 51.51 | |
| 14 | 13.128 | 7.604 | 1.4978 | 82.57 | |
| 15 | −17.619 | 0.200 | | | |
| 16 | 29.449 | 4.349 | 1.4978 | 82.57 | |
| 17 | −18.677 | 3.490 | 1.6838 | 37.64 | |
| 18 | 58.800 | (D18) | | | |
| 19 | 9.615 | 4.304 | 1.4339 | 95.25 | |
| 20 | −49.045 | 9.500 | 1.7321 | 46.18 | |
| 21 | 5.638 | 3.373 | | | |
| 22 | −5.119 | 0.735 | 1.8010 | 34.92 | |
| 23 | −9.287 | 5.198 | 1.7888 | 28.43 | |
| 24 | −7.981 | 140.000 | | | |

[Variable Interval Data]

| | | | |
|---|---|---|---|
| CG | 0.170 | 0.110 | 0.230 |
| D0 | 0.540 | 0.547 | 0.531 |
| D12 | 1.450 | 0.280 | 2.521 |
| D18 | 1.650 | 2.820 | 0.579 |

[Lens Group Data]

| Group | First Surface | Focal length |
|---|---|---|
| G1 | 4 | 9.541 |
| G2 | 19 | −29.538 |

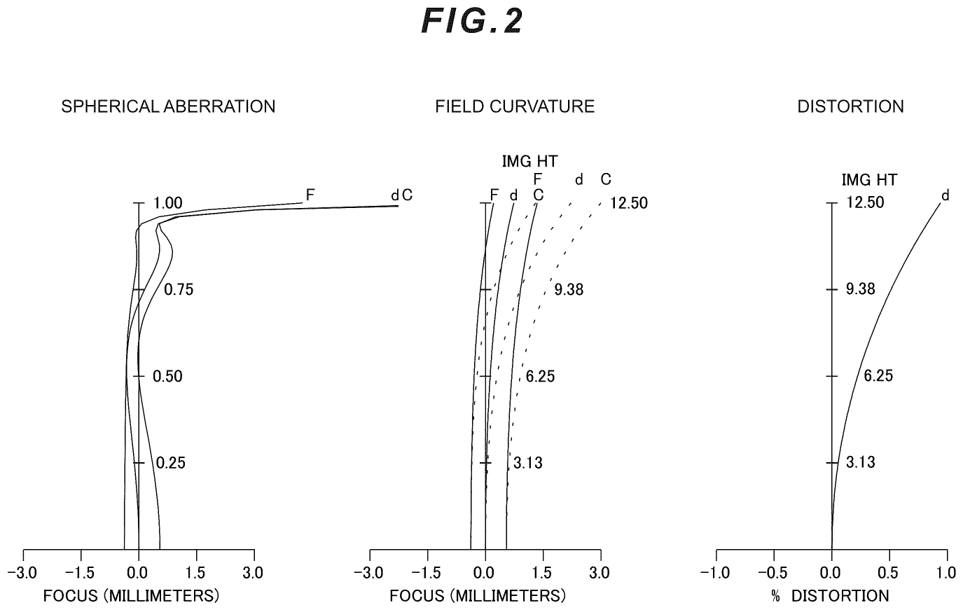

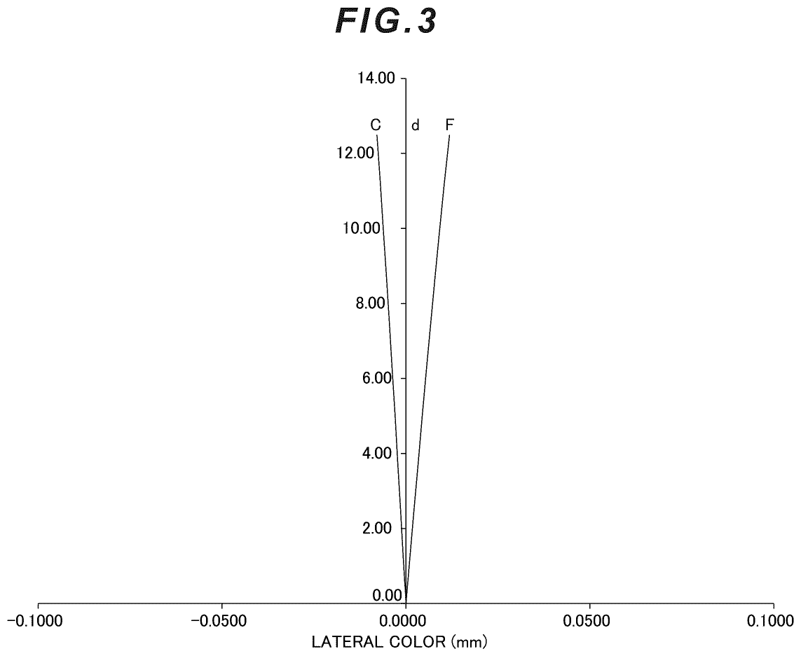

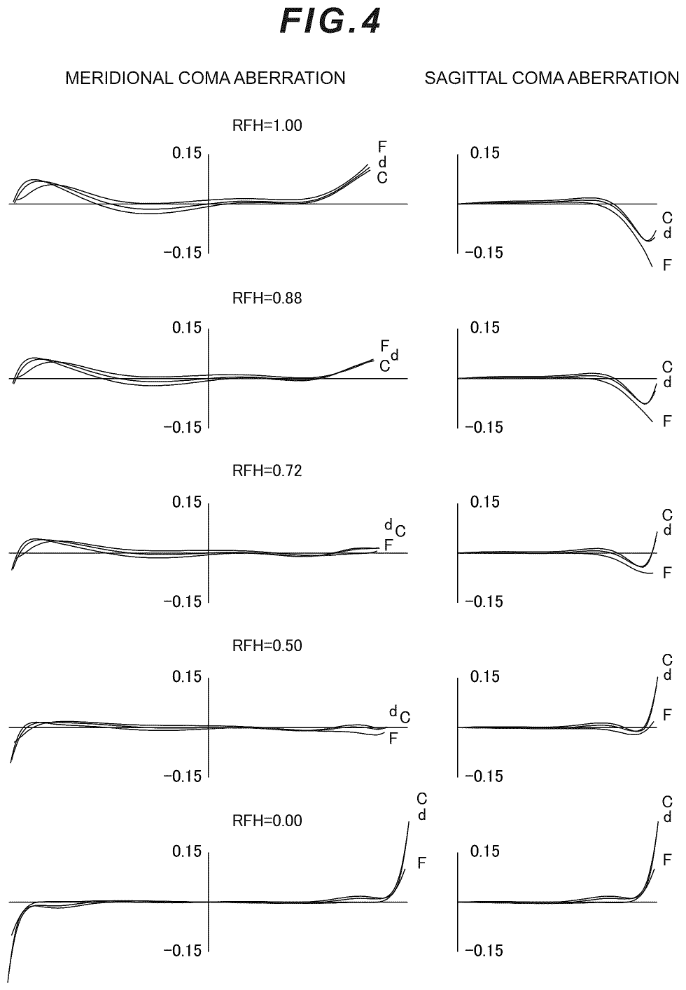

FIG. 2 shows various aberrations (spherical aberration, curvature of field, and distortion) of the microscope objective lens according to First Example. FIG. 3 shows the chromatic aberration of magnification (transverse chromatic aberration) of the microscope objective lens according to First Example. FIG. 4 shows coma aberrations (meridional coma aberration and sagittal coma aberration) of the microscope objective lens according to First Example. Note that the aberration graphs show various aberrations in a state where the microscope objective lens is combined with the imaging lens. In the aberration graphs of FIGS. 2 to 4, d indicates various aberrations with respect to d-line (wavelength λ=587.6 nm), C indicates those with respect to C-line (wavelength λ=656.3 nm), and F indicates those with respect to F-line (wavelength λ=486.1 nm). In the spherical aberration graph, the ordinate axis indicates a normalized value with the maximum value of the entrance pupil radius scaled to one, and the abscissa axis indicates the value [mm] of the aberration for each light beam. In the aberration graph indicating the curvature of field, a solid line indicates a meridional image surface with respect to each wavelength, and a broken line indicates a sagittal image surface with respect to each wavelength. In the aberration graph indicating the curvature of field, the ordinate axis indicates the image height [mm], and the abscissa axis indicates the aberration value [mm]. In the distortion graph (distortion), the ordinate axis indicates the image height [mm], and the abscissa axis indicates the aberration ratio in percentage (% value). In the aberration graph indicating the chromatic aberration of magnification, the ordinate axis indicates the image height [mm], and the abscissa axis indicates the aberration value [mm]. Each coma aberration graph indicates the aberration value in a case where the relative field height RFH ranges from 0.00 to 1.00. Note that also in the aberration graph of each Example described below, symbols similar to those in the present Example are used, and redundant description is omitted.

Each aberration graph shows that the microscope objective lens according to First Example has favorably corrected chromatic aberration and other aberrations over a large wavelength range, and has an excellent imaging performance.

### Second Example

Second Example is described with reference to FIGS. 5 to 8 and Table 2. FIG. 5 is a sectional view showing the configuration of a microscope objective lens according to Second Example. The microscope objective lens OL(2) according to Second Example includes a first lens group G1 having a positive refractive power, and a second lens group G2 having a negative refractive power which are disposed in order from the object along the optical axis. The gap between a distal end of the microscope objective lens OL(2) according to Second Example and the cover glass CV that covers an object is filled with air. Note that the refractive index of the cover glass CV with respect to d-line (wavelength λ=587.6 nm) is assumed as 1.5244.

The first lens group G1 includes, in order from the object along the optical axis: a positive meniscus lens L101 having a concave surface facing the object; a positive meniscus lens L102 having a concave surface facing the object; a first cemented lens CL11 that includes a biconcave negative lens L103 and a biconvex positive lens L104 cemented to each other; a positive meniscus lens L105 having a concave surface facing the object; a second cemented lens CL12 that includes a biconcave negative lens L106 and a biconvex positive lens L107 cemented to each other; and a third cemented lens CL13 that includes a biconvex positive lens L108 and a negative meniscus lens L109 having a concave surface facing the object, the lenses being cemented to each other. The positive meniscus lens L101 disposed closest to the object in the first lens group G1 corresponds to the specified positive meniscus lens described above. The positive meniscus lens L105 of the first lens group G1 corresponds to the image-side lens that satisfies the conditional expression (8) and conditional expression (9) described above.

The second lens group G2 includes, in order from the object along the optical axis: a first cemented meniscus lens CL21 that includes a biconvex positive lens L201 and a biconcave negative lens L202 cemented to each other; and a second cemented meniscus lens CL22 that includes a negative meniscus lens L203 having a concave surface facing the object, and a positive meniscus lens L204 having a concave surface facing the object, the lenses being cemented to each other. The first cemented meniscus lens CL21 is a cemented meniscus lens having a concave surface facing the image. The second cemented meniscus lens CL22 is a cemented meniscus lens having a concave surface facing the object (meniscus component).

Note that it is configured to allow the second cemented lens CL12 and the third cemented lens CL13 of the first lens group G1 to move along the optical axis depending on the thickness of the cover glass CV. The second cemented lens CL12 and the third cemented lens CL13 of the first lens group G1 constitute the partial group G1a described above.

Table 2 below lists the values of data of the microscope objective lens according to Second Example. Note that the first surface is the object surface.

TABLE 2
[General Data]
β = 30.0 times
f = 6.667
NA = 0.920
φ = 12.267
TL = 63.540
[Lens Data]

| Surface | | | | | |
|---|---|---|---|---|---|
| Number | R | D | nd | νd | θgF |
| 1 | ∞ | 0.000 | | | |
| 2 | ∞ | 0.170 | 1.5244 | 54.30 | |
| | | (CG) | | | |
| 3 | ∞ | 0.540 | | | |
| | | (D0) | | | |
| 4 | −3.380 | 4.171 | 1.6285 | 59.17 | 0.5557 |
| 5 | −3.832 | 1.976 | | | |
| 6 | −25.062 | 6.388 | 1.4978 | 82.57 | |
| 7 | −9.189 | 0.250 | | | |
| 8 | −1171.983 | 0.700 | 1.6127 | 44.46 | |
| 9 | 11.113 | 7.792 | 1.5932 | 67.90 | |
| 10 | −21.458 | 0.250 | | | |
| 11 | −35.057 | 1.752 | 1.7558 | 24.71 | 0.6290 |
| 12 | −26.565 | (D12) | | | |
| 13 | −69.555 | 0.700 | 1.7340 | 51.51 | |
| 14 | 13.763 | 7.271 | 1.4978 | 82.57 | |
| 15 | −17.046 | 0.250 | | | |
| 16 | 39.282 | 4.014 | 1.4978 | 82.57 | |
| 17 | −22.052 | 0.700 | 1.6838 | 37.64 | |
| 18 | −157.531 | (D18) | | | |
| 19 | 12.883 | 4.151 | 1.4339 | 95.25 | |
| 20 | −80.934 | 10.000 | 1.7321 | 46.18 | |
| 21 | 8.209 | 4.041 | | | |
| 22 | −6.924 | 0.700 | 1.7550 | 52.34 | |
| 23 | −14.385 | 5.436 | 1.7380 | 32.33 | |
| 24 | −9.612 | 130.000 | | | |

[Variable Interval Data]

| | | | |
|---|---|---|---|
| CG | 0.170 | 0.110 | 0.230 |
| D0 | 0.540 | 0.555 | 0.525 |
| D12 | 1.500 | 1.099 | 1.896 |
| D18 | 1.500 | 1.901 | 1.104 |

[Lens Group Data]

| Group | First Surface | Focal Length |
|---|---|---|
| G1 | 4 | 9.981 |
| G2 | 19 | −37.435 |

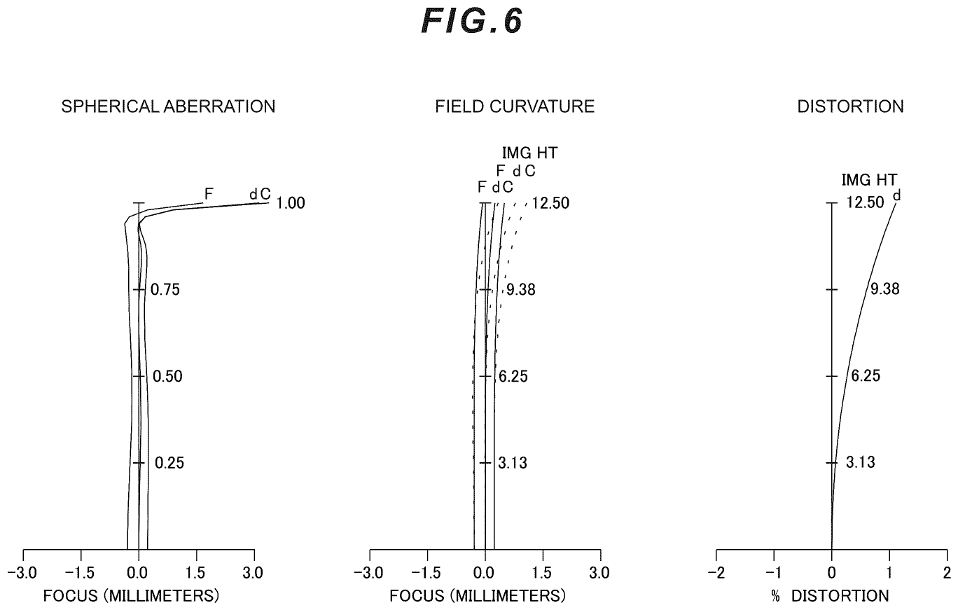

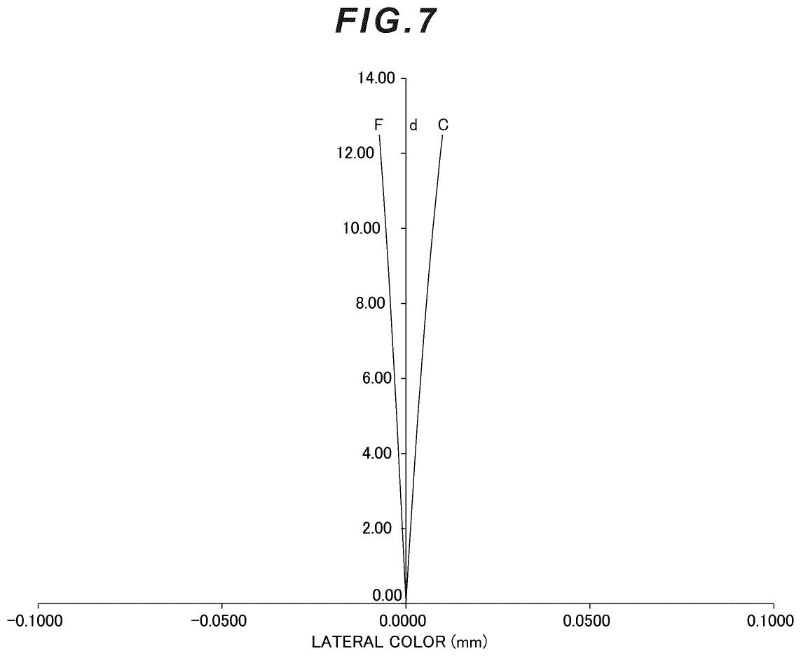

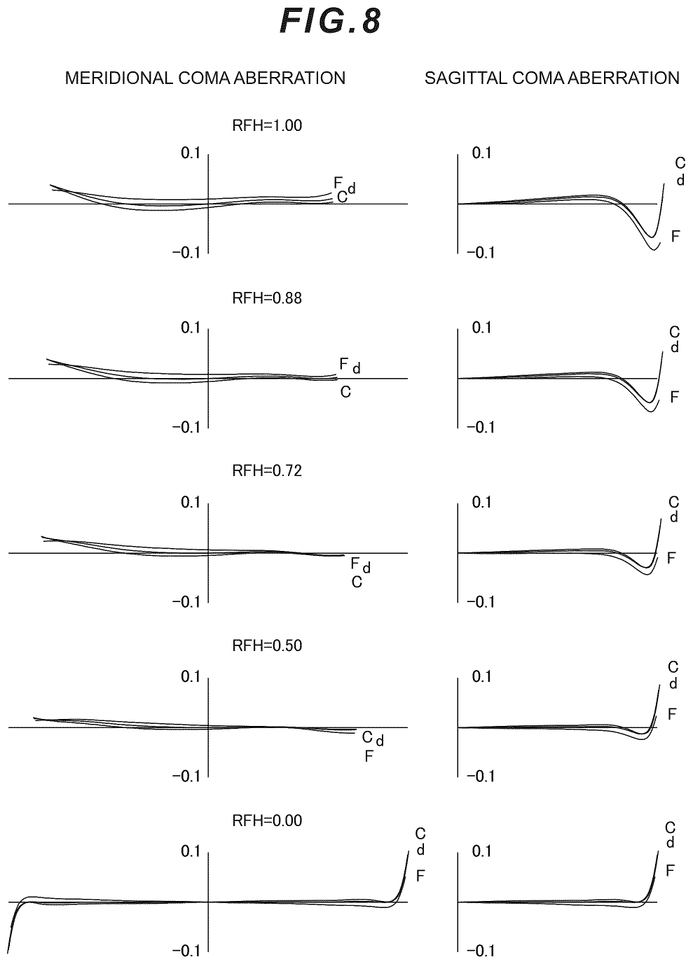

FIG. 6 shows various aberrations (spherical aberration, curvature of field, and distortion) of the microscope objective lens according to Second Example. FIG. 7 shows the chromatic aberration of magnification (transverse chromatic aberration) of the microscope objective lens according to Second Example. FIG. 8 shows coma aberrations (meridional coma aberration and sagittal coma aberration) of the microscope objective lens according to Second Example. Each aberration graph shows that the microscope objective lens according to Second Example has favorably corrected chromatic aberration and other aberrations over a large wavelength range, and has an excellent imaging performance.

### Third Example

Third Example is described with reference to FIGS. 9 to 12 and Table 3. FIG. 9 is a sectional view showing the configuration of a microscope objective lens according to Third Example. The microscope objective lens OL(3) according to Third Example includes a first lens group G1 having a positive refractive power, and a second lens group G2 having a negative refractive power which are disposed in order from the object along the optical axis. The gap between a distal end of the microscope objective lens OL(3) according to Third Example and the cover glass CV that covers an object is filled with immersion liquid (water). Note that the refractive index of the immersion liquid with respect to d-line (wavelength λ=587.6 nm) is assumed as 1.3326. Note that the refractive index of the cover glass CV with respect to d-line is assumed as 1.5244.

The first lens group G1 includes, in order from the object along the optical axis: a first cemented lens CL11 that includes a plano-convex-shaped positive lens L101 having a flat surface facing the object, and a negative meniscus lens L102 having a concave surface facing the object, the lenses being cemented to each other; a positive meniscus lens L103 having a concave surface facing the object; a second cemented lens CL12 that includes a positive meniscus lens L104 having a concave surface facing the object, and a negative meniscus lens L105 having a concave surface facing the object, the lenses being cemented to each other; a biconvex positive lens L106; a third cemented lens CL13 that includes a biconvex positive lens L108, a biconcave negative lens L108, and a biconvex positive lens L109, the lenses being cemented to each other; and a fourth cemented lens CL14 that includes a negative meniscus lens L110 having a convex surface facing the object, and a biconvex positive lens L111, the lenses being cemented to each other. The positive meniscus lens L103 disposed side by side with, and closer to the image than, the first cemented lens CL11 in the first lens group G1 corresponds to the specified positive meniscus lens described above. The positive meniscus lens L104 of the first lens group G1 corresponds to the image-side lens that satisfies the conditional expressions (10) to (13) described above.

The second lens group G2 includes, in order from the object along the optical axis: a first cemented meniscus lens CL21 that includes a positive meniscus lens L201 having a convex surface facing the object, and a negative meniscus lens L202 having a convex surface facing the object, the lenses being cemented to each other; and a second cemented meniscus lens CL22 that includes a negative meniscus lens L203 having a concave surface facing the object, and a positive meniscus lens L204 having a concave surface facing the object, the lenses being cemented to each other. The first cemented meniscus lens CL21 is a cemented meniscus lens having a concave surface facing the image. The second cemented meniscus lens CL22 is a cemented meniscus lens having a concave surface facing the object (meniscus component).

Note that it is configured to allow the fourth cemented lens CL14 of the first lens group G1, and the second lens group G2 to move along the optical axis depending on the thickness of the cover glass CV. The fourth cemented lens CL14 of the first lens group G1 constitutes the partial group G1a described above.

Table 3 below lists the values of data of the microscope objective lens according to Third Example. Note that the first surface is the object surface.

TABLE 3
[General Data]
β = 20.0 times
f = 10.000
NA = 0.950
φ = 19.000
TL = 62.975
[Lens Data]

| Surface | | | | | |
|---|---|---|---|---|---|
| Number | R | D | nd | νd | θgF |
| 1 | ∞ | 0.000 | 1.3326 | 55.89 | |
| 2 | ∞ | 0.170 | 1.5244 | 54.28 | |
| | | (CG) | | | |
| 3 | ∞ | 1.055 | 1.3326 | 55.89 | |
| | | (D0) | | | |
| 4 | ∞ | 0.990 | 1.4585 | 67.85 | |
| 5 | −2.020 | 6.353 | 2.0509 | 26.94 | |
| 6 | −8.390 | 0.200 | | | |
| 7 | 21.531 | 2.929 | 1.6285 | 59.17 | 0.5557 |
| 8 | −11.392 | 0.200 | | | |
| 9 | −85.912 | 4.693 | 1.6285 | 59.17 | 0.5557 |
| 10 | −12.890 | 1.000 | 1.6127 | 44.46 | |
| 11 | −24.732 | 0.200 | | | |
| 12 | 59.134 | 3.979 | 1.4560 | 91.37 | |
| 13 | −35.993 | 0.200 | | | |
| 14 | 18.298 | 6.282 | 1.4343 | 94.77 | |
| 15 | −47.404 | 0.700 | 1.7340 | 51.47 | |
| 16 | 17.642 | 7.033 | 1.4339 | 95.25 | |
| 17 | −32.322 | (D17) | | | |
| 18 | 63.071 | 0.700 | 1.8340 | 37.16 | |
| 19 | 12.507 | 5.653 | 1.4343 | 94.77 | |
| 20 | −43.873 | 0.200 | | | |
| 21 | 13.290 | 3.308 | 1.5691 | 71.34 | |
| 22 | 33.145 | 3.408 | 1.7321 | 46.18 | |
| 23 | 11.362 | 6.367 | | | |
| 24 | −9.283 | 3.094 | 1.6393 | 44.87 | |
| 25 | −32.362 | 3.687 | 1.9037 | 31.34 | |
| 26 | −14.467 | 140.000 | | | |

[Variable Interval Data]

| | | | |
|---|---|---|---|
| CG | 0.170 | 0.110 | 0.230 |
| D0 | 1.055 | 1.109 | 1.001 |
| D17 | 1.800 | 1.717 | 1.879 |

[Lens Group Data]

| Group | First Surface | Focal Length |
|---|---|---|
| G1 | 4 | 9.433 |
| G2 | 21 | −402.240 |

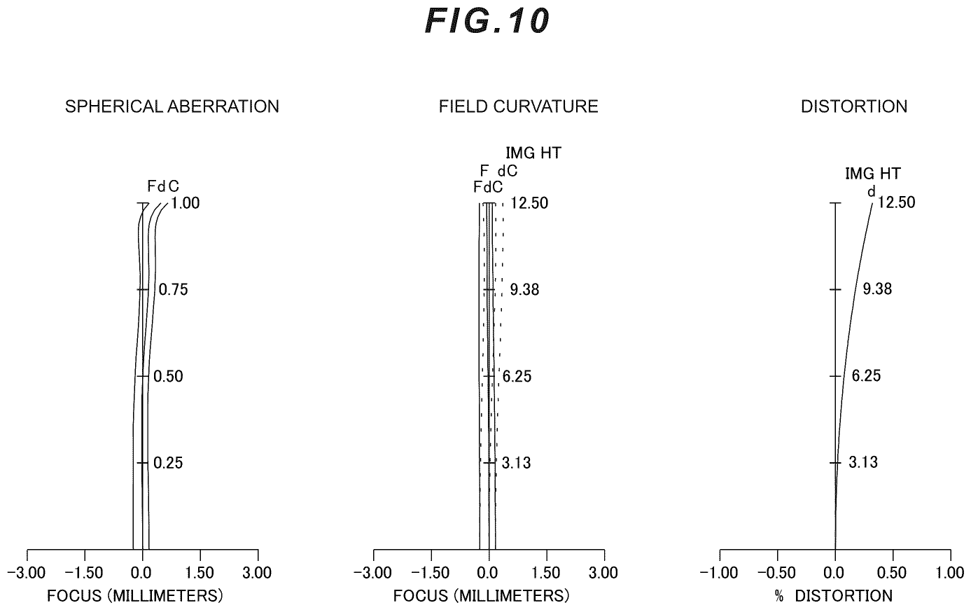

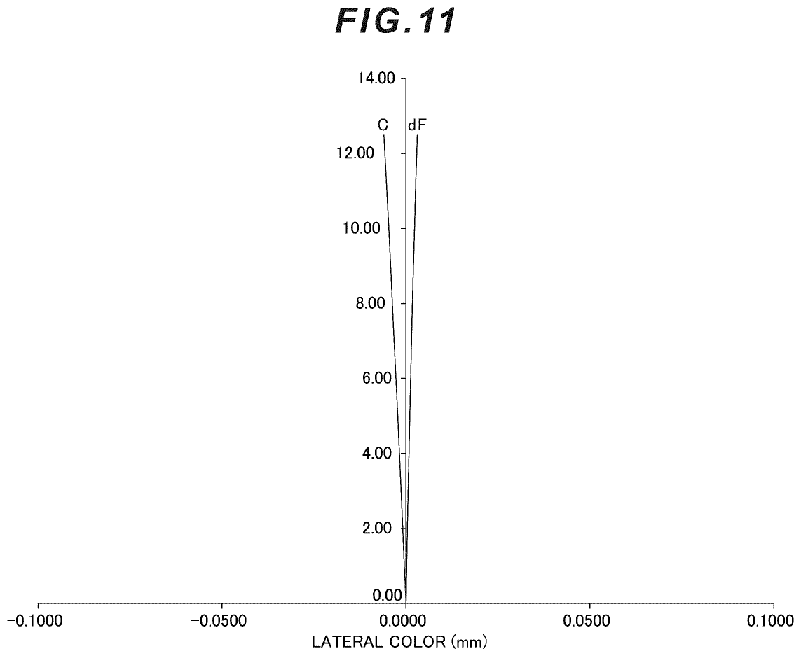

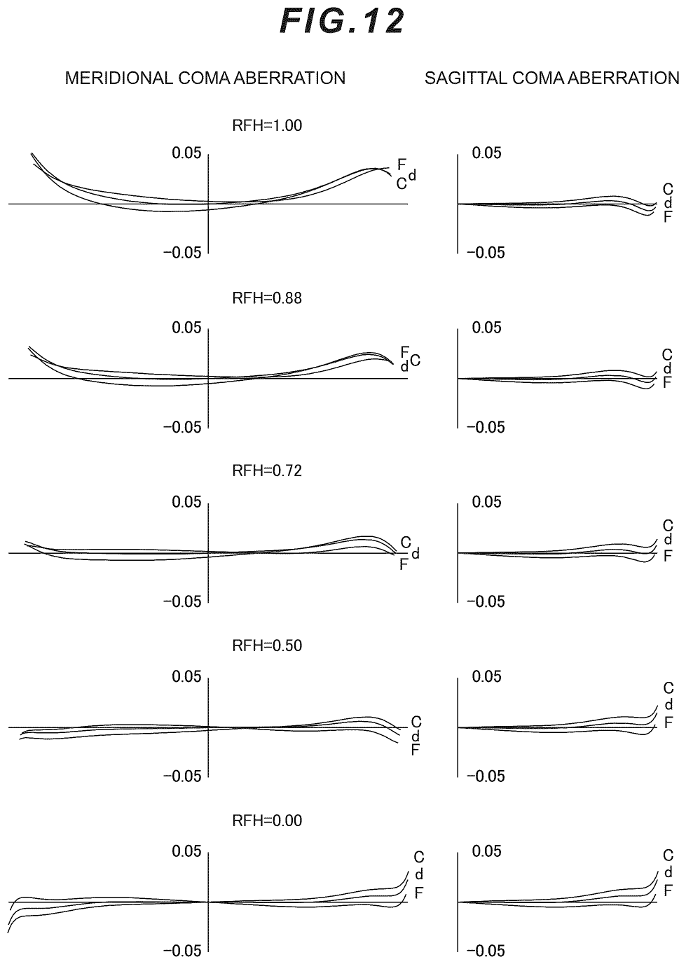

FIG. 10 shows various aberrations (spherical aberration, curvature of field, and distortion) of the microscope objective lens according to Third Example. FIG. 11 shows the chromatic aberration of magnification (transverse chromatic aberration) of the microscope objective lens according to Third Example. FIG. 12 shows coma aberrations (meridional coma aberration and sagittal coma aberration) of the microscope objective lens according to Third Example. Each aberration graph shows that the microscope objective lens according to Third Example has favorably corrected chromatic aberration and other aberrations over a large wavelength range, and has an excellent imaging performance.

### Fourth Example

Fourth Example is described with reference to FIGS. 13 to 16 and Table 4. FIG. 13 is a sectional view showing the configuration of a microscope objective lens according to Fourth Example. The microscope objective lens OL(4) according to Fourth Example includes a first lens group G1 having a positive refractive power, and a second lens group G2 having a negative refractive power which are disposed in order from the object along the optical axis. The gap between a distal end of the microscope objective lens OL(4) according to Fourth Example and the cover glass CV that covers an object is filled with air. Note that the refractive index of the cover glass CV with respect to d-line (wavelength λ=587.6 nm) is assumed as 1.5244.

The first lens group G1 includes, in order from the object along the optical axis: a positive meniscus lens L101 having a concave surface facing the object; a positive meniscus lens L102 having a concave surface facing the object; a first cemented lens CL11 that includes a biconcave negative lens L103 and a biconvex positive lens L104 cemented to each other; a positive meniscus lens L105 having a concave surface facing the object; a second cemented lens CL12 that includes a negative meniscus lens L106 having a convex surface facing the object, and a biconvex positive lens L107 cemented to each other; and a third cemented lens CL13 that includes a biconvex positive lens L108 and a biconcave negative lens L109 cemented to each other. The positive meniscus lens L101 disposed closest to the object in the first lens group G1 corresponds to the specified positive meniscus lens described above. The positive meniscus lens L105 of the first lens group G1 corresponds to the image-side lens that satisfies the conditional expression (8) and conditional expression (9) described above.

The second lens group G2 includes, in order from the object along the optical axis: a first cemented meniscus lens CL21 that includes a biconvex positive lens L201 and a biconcave negative lens L202 cemented to each other; and a second cemented meniscus lens CL22 that includes a negative meniscus lens L203 having a concave surface facing the object, and a positive meniscus lens L204 having a concave surface facing the object, the lenses being cemented to each other. The first cemented meniscus lens CL21 is a cemented meniscus lens having a concave surface facing the image. The second cemented meniscus lens CL22 is a cemented meniscus lens having a concave surface facing the object (meniscus component).

Note that it is configured to allow the second cemented lens CL12 and the third cemented lens CL13 of the first lens group G1 to move along the optical axis depending on the thickness of the cover glass CV. The second cemented lens CL12 and the third cemented lens CL13 of the first lens group G1 constitute the partial group G1a described above.

Table 4 below lists the values of data of the microscope objective lens according to Fourth Example. Note that the first surface is the object surface.

TABLE 4
[General Data]
β = 40.0 times
f = 5.000
NA = 0.950
φ = 9.500
TL = 63.499
[Lens Data]

| Surface | | | | | |
|---|---|---|---|---|---|
| Number | R | D | nd | νd | θgF |
| 1 | ∞ | 0.000 | | | |
| 2 | ∞ | 0.170 | 1.5244 | 54.30 | |
| | | (CG) | | | |
| 3 | ∞ | 0.540 | | | |
| | | (D0) | | | |
| 4 | −4.105 | 3.159 | 1.6285 | 59.17 | 0.5557 |
| 5 | −2.998 | 3.000 | | | |
| 6 | −13.623 | 3.651 | 1.6285 | 59.17 | 0.5557 |
| 7 | −7.981 | 0.250 | | | |
| 8 | −14.505 | 0.700 | 1.6127 | 44.46 | |
| 9 | 11.828 | 8.225 | 1.5932 | 67.90 | |
| 10 | −13.634 | 0.250 | | | |
| 11 | −519.714 | 2.092 | 1.6638 | 27.35 | 0.6319 |
| 12 | −50.651 | (D12) | | | |
| 13 | 70.731 | 0.700 | 1.7340 | 51.51 | |
| 14 | 13.211 | 7.483 | 1.4978 | 82.57 | |
| 15 | −17.971 | 0.287 | | | |
| 16 | 25.896 | 4.301 | 1.4978 | 82.57 | |
| 17 | −21.034 | 2.967 | 1.6838 | 37.64 | |
| 18 | 48.861 | (D18) | | | |
| 19 | 9.527 | 4.392 | 1.4343 | 94.77 | |
| 20 | −47.855 | 9.504 | 1.7321 | 46.18 | |
| 21 | 5.499 | 3.300 | | | |
| 22 | −5.020 | 0.825 | 1.8010 | 34.92 | |
| 23 | −9.888 | 5.379 | 1.7888 | 28.43 | |
| 24 | −8.038 | 140.000 | | | |

[Variable Interval Data]

| | | | |
|---|---|---|---|
| CG | 0.170 | 0.110 | 0.230 |
| D0 | 0.540 | 0.545 | 0.534 |
| D12 | 1.500 | 0.353 | 2.685 |
| D18 | 1.536 | 2.724 | 0.392 |

[Lens Group Data]

| Group | First Surface | Focal Length |
|---|---|---|
| G1 | 4 | 9.930 |
| G2 | 19 | −28.940 |

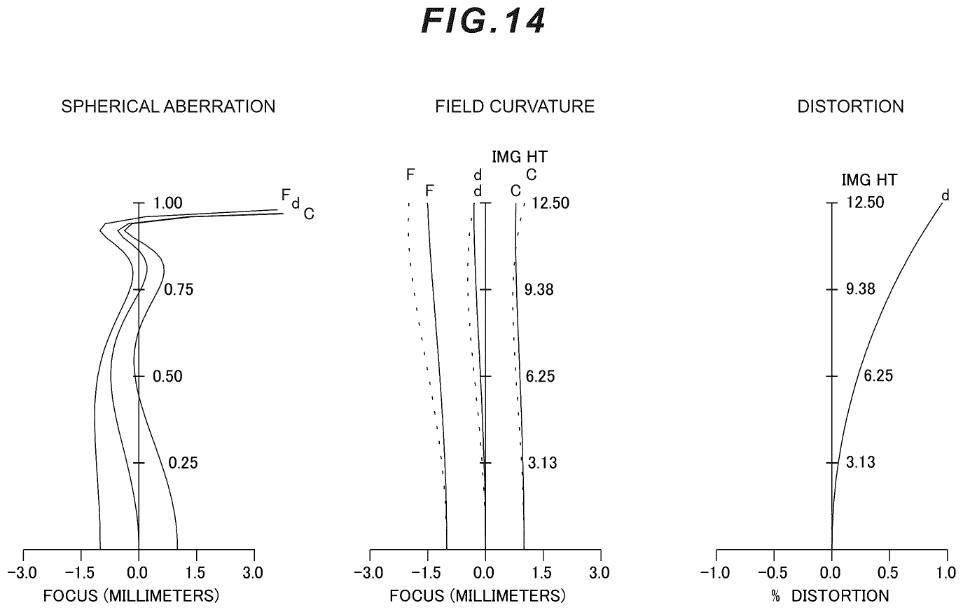

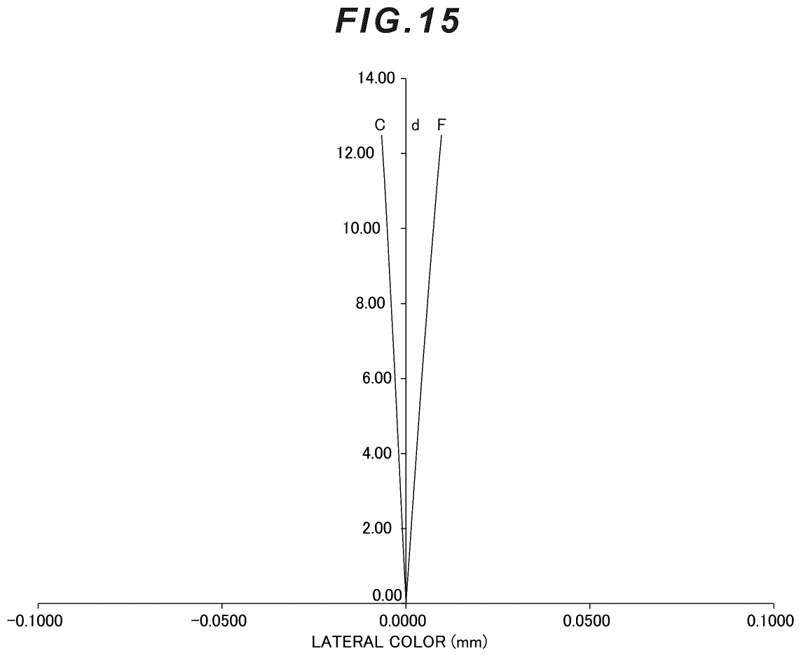

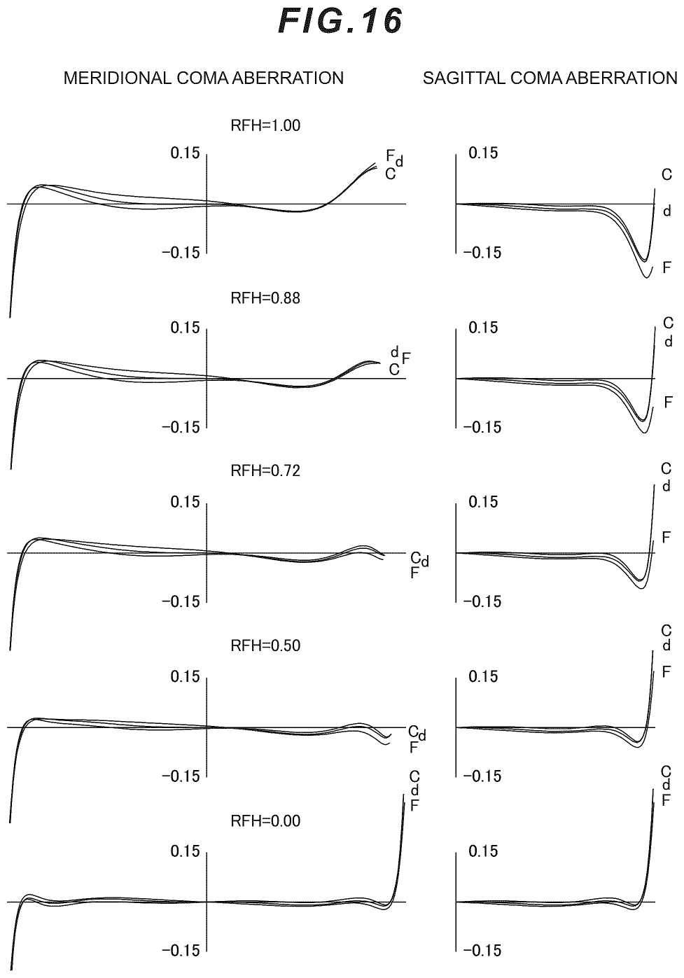

FIG. 14 shows various aberrations (spherical aberration, curvature of field, and distortion) of the microscope objective lens according to Fourth Example. FIG. 15 shows the chromatic aberration of magnification (transverse chromatic aberration) of the microscope objective lens according to Fourth Example. FIG. 16 shows coma aberrations (meridional coma aberration and sagittal coma aberration) of the microscope objective lens according to Fourth Example. Each aberration graph shows that the microscope objective lens according to Fourth Example has favorably corrected chromatic aberration and other aberrations over a large wavelength range, and has an excellent imaging performance.

### Fifth Example

Fifth Example is described with reference to FIGS. 17 to 20 and Table 5. FIG. 17 is a sectional view showing the configuration of a microscope objective lens according to Fifth Example. The microscope objective lens OL(5) according to Fifth Example includes a first lens group G1 having a positive refractive power, and a second lens group G2 having a negative refractive power which are disposed in order from the object along the optical axis. The gap between a distal end of the microscope objective lens OL(5) according to Fifth Example and the cover glass CV that covers an object is filled with air. Note that the refractive index of the cover glass CV with respect to d-line (wavelength λ=587.6 nm) is assumed as 1.5244.

The first lens group G1 includes, in order from the object along the optical axis: a positive meniscus lens L101 having a concave surface facing the object; a positive meniscus lens L102 having a concave surface facing the object; a first cemented lens CL11 that includes a biconcave negative lens L103 and a biconvex positive lens L104 cemented to each other; a positive meniscus lens L105 having a concave surface facing the object; a second cemented lens CL12 that includes a negative meniscus lens L106 having a convex surface facing the object, and a biconvex positive lens L107 cemented to each other; and a third cemented lens CL13 that includes a biconvex positive lens L108 and a biconcave negative lens L109 cemented to each other. The positive meniscus lens L101 disposed closest to the object in the first lens group G1 corresponds to the specified positive meniscus lens described above. The positive meniscus lens L105 of the first lens group G1 corresponds to the image-side lens that satisfies the conditional expression (8) and conditional expression (9) described above.

The second lens group G2 includes, in order from the object along the optical axis: a first cemented meniscus lens CL21 that includes a biconvex positive lens L201 and a biconcave negative lens L202 cemented to each other; and a second cemented meniscus lens CL22 that includes a negative meniscus lens L203 having a concave surface facing the object, and a positive meniscus lens L204 having a concave surface facing the object, the lenses being cemented to each other. The first cemented meniscus lens CL21 is a cemented meniscus lens having a concave surface facing the image. The second cemented meniscus lens CL22 is a cemented meniscus lens having a concave surface facing the object (meniscus component).

Note that it is configured to allow the second cemented lens CL12 and the third cemented lens CL13 of the first lens group G1 to move along the optical axis depending on the thickness of the cover glass CV. The second cemented lens CL12 and the third cemented lens CL13 of the first lens group G1 constitute the partial group G1a described above.

Table 5 below lists the values of data of the microscope objective lens according to Fifth Example. Note that the first surface is the object surface.

TABLE 5
[General Data]
β = 40.0 times
f = 5.000
NA = 0.950
φ = 9.500
TL = 63.531
[Lens Data]

| Surface | | | | | |
|---|---|---|---|---|---|
| Number | R | D | nd | νd | θgF |
| 1 | ∞ | 0.000 | | | |
| 2 | ∞ | 0.170 | 1.5244 | 54.30 | |
| | | (CG) | | | |
| 3 | ∞ | 0.540 | | | |
| | | (D0) | | | |
| 4 | −3.695 | 3.035 | 1.6287 | 59.20 | 0.5545 |
| 5 | −3.037 | 2.805 | | | |
| 6 | −12.594 | 3.733 | 1.4978 | 82.57 | |
| 7 | −6.972 | 0.250 | | | |
| 8 | −21.421 | 0.700 | 1.6127 | 44.46 | |
| 9 | 11.280 | 7.838 | 1.5932 | 67.90 | |
| 10 | −17.009 | 0.250 | | | |
| 11 | −74.011 | 2.629 | 1.6460 | 30.86 | 0.6151 |
| 12 | −24.445 | (D12) | | | |
| 13 | 90.678 | 0.700 | 1.7340 | 51.51 | |
| 14 | 13.544 | 7.509 | 1.4978 | 82.57 | |
| 15 | −17.652 | 0.250 | | | |
| 16 | 29.670 | 4.252 | 1.4978 | 82.57 | |
| 17 | −20.065 | 3.336 | 1.6838 | 37.64 | |
| 18 | 65.602 | (D18) | | | |
| 19 | 9.637 | 4.399 | 1.4339 | 95.25 | |
| 20 | −46.286 | 9.488 | 1.7321 | 46.18 | |
| 21 | 5.624 | 3.454 | | | |
| 22 | −5.114 | 0.720 | 1.8010 | 34.92 | |
| 23 | −9.918 | 5.184 | 1.7888 | 28.43 | |
| 24 | −7.992 | 135.000 | | | |

[Variable Interval Data]

| | | | |
|---|---|---|---|
| CG | 0.170 | 0.110 | 0.230 |
| D0 | 0.540 | 0.545 | 0.534 |
| D12 | 1.500 | 0.339 | 2.615 |
| D18 | 1.500 | 2.669 | 0.394 |

[Lens Group Data]

| Group | First Surface | Focal Length |
|---|---|---|
| G1 | 4 | 9.847 |
| G2 | 19 | −28.671 |

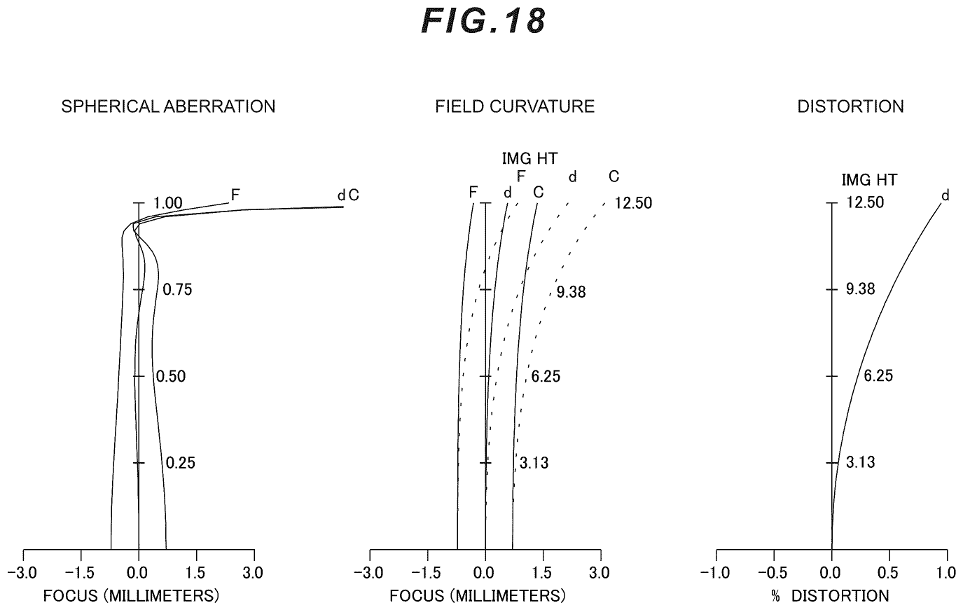

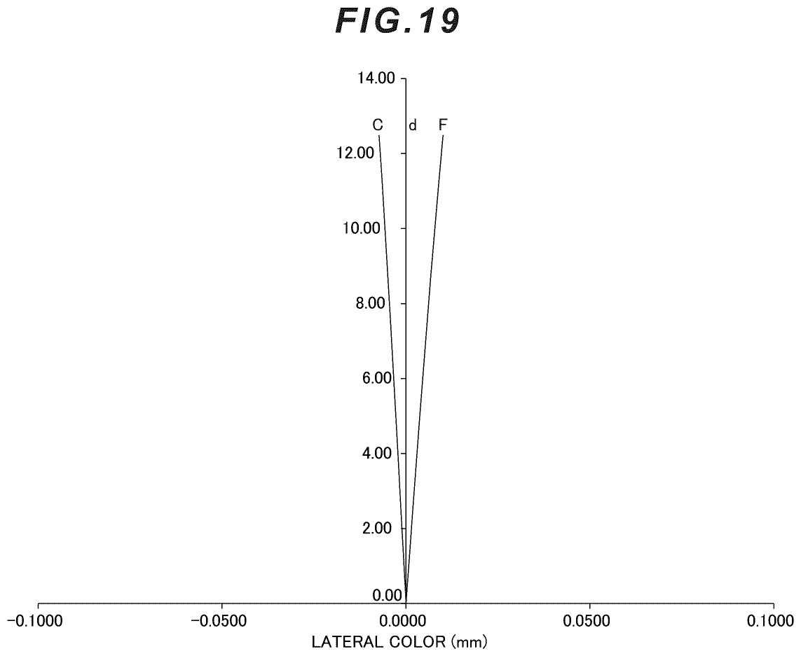

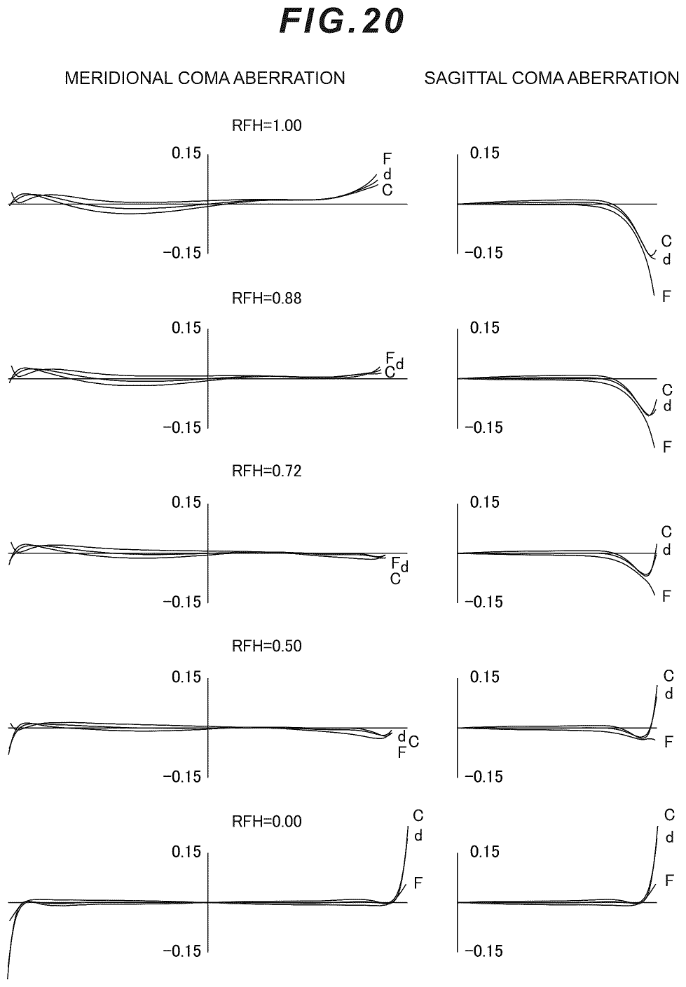

FIG. 18 shows various aberrations (spherical aberration, curvature of field, and distortion) of the microscope objective lens according to Fifth Example. FIG. 19 shows the chromatic aberration of magnification (transverse chromatic aberration) of the microscope objective lens according to Fifth Example. FIG. 20 shows coma aberrations (meridional coma aberration and sagittal coma aberration) of the microscope objective lens according to Fifth Example. Each aberration graph shows that the microscope objective lens according to Fifth Example has favorably corrected chromatic aberration and other aberrations over a large wavelength range, and has an excellent imaging performance.

### Sixth Example

Sixth Example is described with reference to FIGS. 21 to 24 and Table 6. FIG. 21 is a sectional view showing the configuration of a microscope objective lens according to Sixth Example. The microscope objective lens OL(6) according to Sixth Example includes a first lens group G1 having a positive refractive power, and a second lens group G2 having a negative refractive power which are disposed in order from the object along the optical axis. The gap between a distal end of the microscope objective lens OL(6) according to Sixth Example and the cover glass CV that covers an object is filled with immersion liquid (water). Note that the refractive index of the immersion liquid with respect to d-line (wavelength λ=587.6 nm) is assumed as 1.3326. Note that the refractive index of the cover glass CV with respect to d-line is assumed as 1.5244.

The first lens group G1 includes, in order from the object along the optical axis: a first cemented lens CL11 that includes a plano-convex-shaped positive lens L101 having a flat surface facing the object, and a negative meniscus lens L102 having a concave surface facing the object, the lenses being cemented to each other; a positive meniscus lens L103 having a concave surface facing the object; a second cemented lens CL12 that includes a positive meniscus lens L104 having a concave surface facing the object, and a negative meniscus lens L105 having a concave surface facing the object, the lenses being cemented to each other; a biconvex positive lens L106; a third cemented lens CL13 that includes a biconvex positive lens L108, a biconcave negative lens L108, and a biconvex positive lens L109, the lenses being cemented to each other; and a fourth cemented lens CL14 that includes a negative meniscus lens L110 having a convex surface facing the object, and a biconvex positive lens L111, the lenses being cemented to each other. The positive meniscus lens L103 disposed side by side with, and closer to the image than, the first cemented lens CL11 in the first lens group G1 corresponds to the specified positive meniscus lens described above. The positive meniscus lens L104 of the first lens group G1 corresponds to the image-side lens that satisfies the conditional expressions (10) to (13) described above.

The second lens group G2 includes, in order from the object along the optical axis: a first cemented meniscus lens CL21 that includes a positive meniscus lens L201 having a convex surface facing the object, and a negative meniscus lens L202 having a convex surface facing the object, the lenses being cemented to each other; and a second cemented meniscus lens CL22 that includes a negative meniscus lens L203 having a concave surface facing the object, and a positive meniscus lens L204 having a concave surface facing the object, the lenses being cemented to each other. The first cemented meniscus lens CL21 is a cemented meniscus lens having a concave surface facing the image. The second cemented meniscus lens CL22 is a cemented meniscus lens having a concave surface facing the object.

Note that it is configured to allow the fourth cemented lens CL14 of the first lens group G1, and the second lens group G2 to move along the optical axis depending on the thickness of the cover glass CV. The fourth cemented lens CL14 of the first lens group G1 constitutes the partial group G1a described above.

Table 6 below lists the values of data of the microscope objective lens according to Sixth Example. Note that the first surface is the object surface.

TABLE 6
[General Data]
β = 20.0 times
f = 10.000
NA = 0.950
φ = 19.000
TL = 62.975
[Lens Data]

| Surface | | | | | |
|---|---|---|---|---|---|
| Number | R | D | nd | νd | θgF |
| 1 | ∞ | 0.000 | 1.3326 | 55.89 | |
| 2 | ∞ | 0.170 | 1.5244 | 54.28 | |
| | | (CG) | | | |
| 3 | ∞ | 1.055 | 1.3326 | 55.89 | |
| | | (D0) | | | |
| 4 | ∞ | 0.990 | 1.4585 | 67.85 | |
| 5 | −1.976 | 6.211 | 2.0509 | 26.94 | |
| 6 | −8.274 | 0.200 | | | |
| 7 | −19.747 | 2.923 | 1.6693 | 49.05 | 0.5681 |
| 8 | −10.945 | 0.200 | | | |
| 9 | −109.950 | 5.369 | 1.6285 | 59.17 | 0.5557 |
| 10 | −11.683 | 1.000 | 1.6127 | 44.46 | |
| 11 | −27.810 | 0.200 | | | |
| 12 | 53.865 | 4.109 | 1.4560 | 91.37 | |
| 13 | −36.420 | 0.200 | | | |
| 14 | 18.273 | 6.254 | 1.4343 | 94.77 | |
| 15 | −49.852 | 0.700 | 1.7340 | 51.47 | |
| 16 | 17.007 | 6.434 | 1.4339 | 95.25 | |
| 17 | −32.905 | (D17) | | | |
| 18 | 51.956 | 0.700 | 1.8340 | 37.16 | |
| 19 | 12.028 | 5.596 | 1.4343 | 94.77 | |
| 20 | −53.519 | 0.200 | | | |
| 21 | 12.434 | 3.621 | 1.5691 | 71.34 | |
| 22 | 33.553 | 2.771 | 1.7321 | 46.18 | |
| 23 | 10.691 | 6.753 | | | |
| 24 | −9.194 | 3.088 | 1.6393 | 44.87 | |
| 25 | −30.497 | 3.657 | 1.9037 | 31.34 | |
| 26 | −14.194 | 136.000 | | | |

[Variable Interval Data]

| | | | |
|---|---|---|---|
| CG | 0.170 | 0.110 | 0.230 |
| D0 | 1.055 | 1.109 | 1.001 |
| D17 | 1.800 | 1.720 | 1.884 |

[Lens Group Data]

| Group | First Surface | Focal Length |
|---|---|---|
| G1 | 4 | 9.366 |
| G2 | 21 | −426.746 |

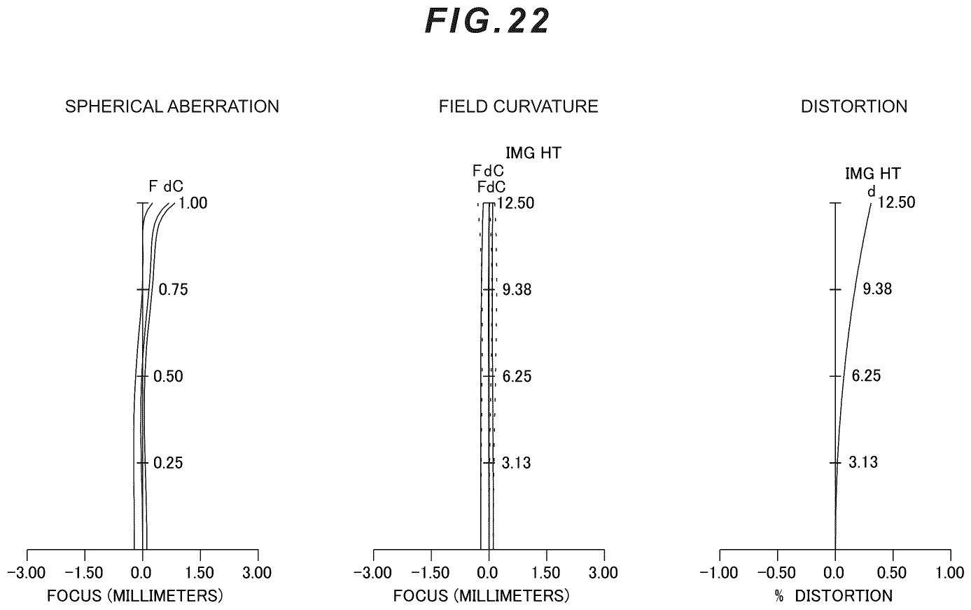

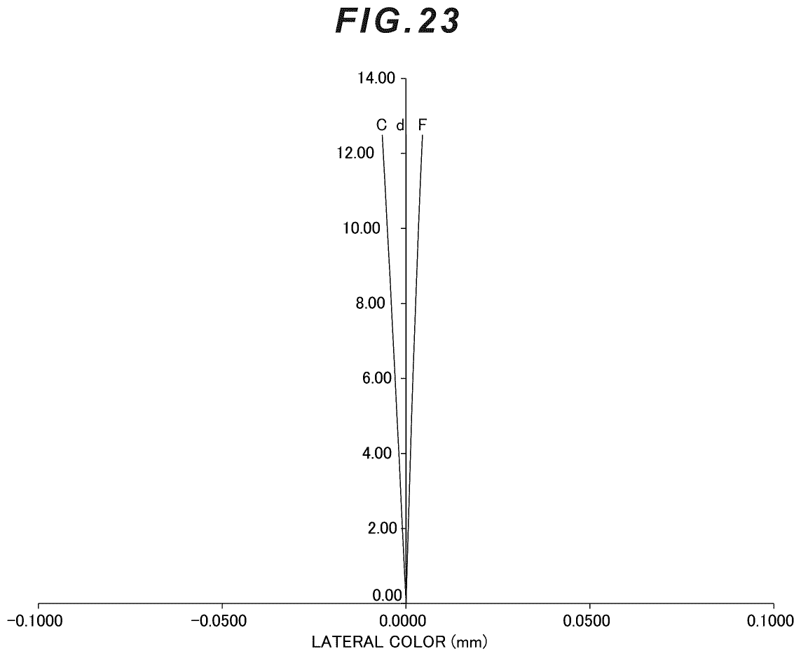

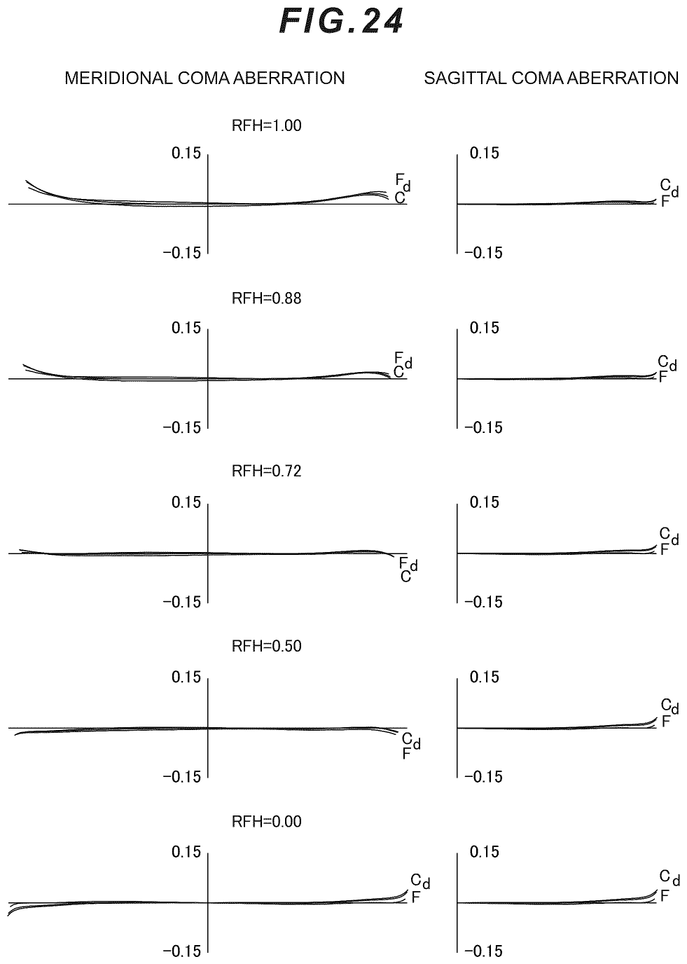

FIG. 22 shows various aberrations (spherical aberration, curvature of field, and distortion) of the microscope objective lens according to Sixth Example. FIG. 23 shows the chromatic aberration of magnification (transverse chromatic aberration) of the microscope objective lens according to Sixth Example. FIG. 24 shows coma aberrations (meridional coma aberration and sagittal coma aberration) of the microscope objective lens according to Sixth Example. Each aberration graph shows that the microscope objective lens according to Sixth Example has favorably corrected chromatic aberration and other aberrations over a large wavelength range, and has an excellent imaging performance.

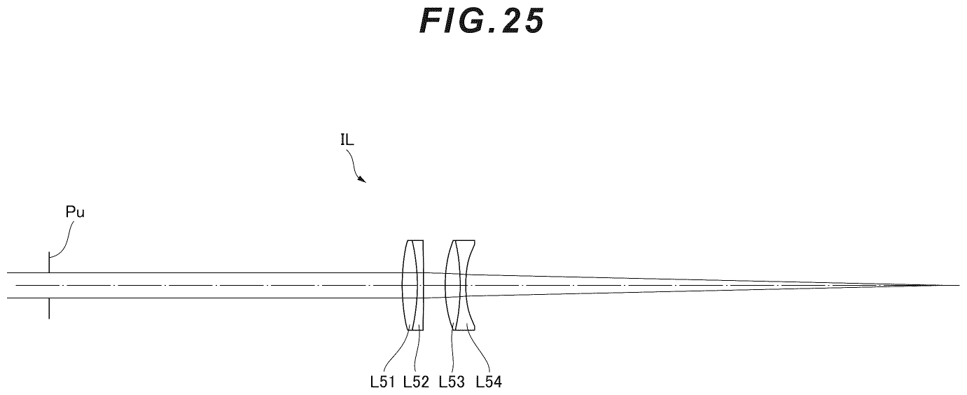

Since the microscope objective lens according to each Example is an infinity-corrected type lens, it is used in combination with an imaging lens that forms an image of light from the microscope objective lens. An example of the imaging lens used in combination with the microscope objective lens is described with reference to FIG. 25 and Table 7. FIG. 25 is a sectional view showing the configuration of the imaging lens used in combination with the microscope objective lens according to each Example. The graphs showing various aberrations of the microscope objective lens according to each Example are those in the case of use in combination with this imaging lens. The imaging lens IL shown in FIG. 25 includes, in order from the object: a cemented lens that includes a biconvex positive lens L51 and a biconcave negative lens L52 cemented to each other; and a cemented lens that includes a biconvex positive lens L53 and a biconcave negative lens L54 cemented to each other. The imaging lens IL is disposed closer to the image than the microscope objective lens according to each Example. FIG. 25 shows the entrance pupil surface Pu of the imaging lens IL.

Table 7 below lists the values of data of the imaging lens. Note that in the table of [General Data], f′ indicates the focal length of the imaging lens. In the table of [Lens Data], the surface number, R, D, nd, and vd are the same as those described with reference to Tables 1 to 6 described above.

TABLE 7
[General Data]
f′ = 200
[Lens Data]

| Surface | | | | |
|---|---|---|---|---|
| Number | R | D | nd | νd |
| 1 | 75.043 | 5.100 | 1.6228 | 57.03 |
| 2 | −75.043 | 2.000 | 1.7495 | 35.19 |
| 3 | 1600.580 | 7.500 | | |
| 4 | 50.256 | 5.100 | 1.6676 | 41.96 |
| 5 | −84.541 | 1.800 | 1.6127 | 44.40 |
| 6 | 36.911 | 168.438 | | |

Next, the table of [Conditional Expression Corresponding Value] is shown below. This table collectively lists values corresponding to the conditional expressions (1) to (13) with respect to all Examples (First to Sixth Examples).

$$0 < θ gFA + 0.0015 \times vdA - 0.6395 \qquad Conditional expression ( 1 )$$

$$1.6 < ndA < 1.85 \qquad Conditional expression ( 2 )$$

$$39.5 < vdA < 75. \qquad Conditional expression ( 3 )$$

$$0 < θ gFA + 0.016 \times vdA - 0.646 \qquad Conditional expression ( 4 )$$

$$- 10 < GAR 1 / DGA 1 < 1 \qquad Conditional expression ( 5 )$$

$$- 10 < GAR 2 / DGA 2 < 0 \qquad Conditional expression ( 6 )$$

$$- 0.3 < ( GAR 2 - GAR 1 + GAL ) / TL < 0.3 \qquad Conditional expression ( 7 )$$

$$0 < θ gFB 1 + 0.015 \times vdB 1 - 0.6395 \qquad Conditional expression ( 8 )$$

$$vdB 1 < 40. \qquad Conditional expression ( 9 )$$

$$0 < θ gFB 2 + 0.015 \times vdB 2 - 0.6395 \qquad Conditional expression ( 10 )$$

$$1.6 < ndB 2 < 1.85 \qquad Conditional expression ( 11 )$$

$$3950 < vdB 2 < 75. \qquad Conditional expression ( 12 )$$

$$0 < θ gFB 2 + 0.0016 \times vdB 2 - 0.646 \qquad Conditional expression ( 13 )$$

### Corresponding Values of Conditional Expressions

### First to Third Examples

| Conditional | First | Second | Third |
|---|---|---|---|
| Expression | Example | Example | Example |
| (1) | 0.0050 | 0.0050 | 0.0050 |
| (2) | 1.6285 | 1.6285 | 1.6285 |
| (3) | 59.17 | 59.17 | 59.17 |
| (4) | 0.0044 | 0.0044 | 0.0044 |
| (5) | −5.0111 | −4.7611 | −2.4557 |
| (6) | −0.8259 | −0.7852 | −0.9740 |
| (7) | 0.0549 | 0.0585 | 0.2075 |
| (8) | 0.0266 | 0.0266 | — |
| (9) | 24.71 | 24.71 | — |
| (10) | — | — | 0.0050 |
| (11) | — | — | 1.6285 |
| (12) | — | — | 59.17 |
| (13) | — | — | 0.0044 |

### Corresponding Values of Conditional Expressions

### Fourth to Sixth Examples

| Conditional | Fourth | Fifth | Sixth |
|---|---|---|---|
| Expression | Example | Example | Example |
| (1) | 0.0050 | 0.0038 | 0.0022 |
| (2) | 1.6285 | 1.6287 | 1.6693 |
| (3) | 59.17 | 59.20 | 49.05 |
| (4) | 0.0044 | 0.0032 | 0.0006 |
| (5) | −5.7812 | −5.2049 | −2.2891 |
| (6) | −0.7749 | −0.8110 | −0.9477 |
| (7) | 0.0672 | 0.0581 | 0.1862 |
| (8) | 0.0334 | 0.0219 | — |
| (9) | 27.35 | 30.86 | — |
| (10) | — | — | 0.0050 |
| (11) | — | — | 1.6285 |
| (12) | — | — | 59.17 |
| (13) | — | — | 0.0044 |

Each Example described above can achieve the microscope objective lens with chromatic aberration and other aberrations favorably corrected.

Here, each of Examples described above indicates a specific example of the present embodiment, and the present embodiment is not limited by them.

### EXPLANATION OF NUMERALS AND CHARACTERS

G1 First lens group G2 Second lens group

### RELATED APPLICATIONS

This is a continuation of PCT International Application No. PCT/JP2023/045401, filed on 19 Dec. 2023, which is hereby incorporated by reference. This application also claims the benefit of Japanese Patent Application No. 2022-172101, filed in Japan on 27 Oct. 2022 which is hereby incorporated by reference.

1. A microscope objective lens essentially consisting of a first lens group, and a second lens group having a negative refractive power which are disposed in order from an object along an optical axis, wherein
the second lens group includes a cemented meniscus lens having a concave surface facing an image, and a meniscus lens component having a concave surface facing the object which are disposed in order from the object along the optical axis, and
the first lens group includes a specified positive meniscus lens that satisfies the following conditional expressions,
$$0 < θ gFA + 0.0015 \times vdA - 0.6395 ,$$
$$1.6 < ndA < 1.85 , and$$
$$39.5 < vdA < 75. ,$$
where ndA: a refractive index of the specified positive meniscus lens with respect to d-line,
vdA: an Abbe number of the specified positive meniscus lens, and
θgFA: a partial dispersion ratio of the specified positive meniscus lens, defined by the following expression when it is assumed that a refractive index of the specified positive meniscus lens with respect to g-line is ngA, a refractive index of the specified positive meniscus lens with respect to F-line is nFA, and a refractive index of the specified positive meniscus lens with respect to C-line is nCA,
$$θ gFA = ( ngA - nFA ) / ( nFA - nCA ) .$$

2. A microscope objective lens essentially consisting of a first lens group, and a second lens group having a negative refractive power which are disposed in order from an object along an optical axis,
wherein
the second lens group includes a cemented meniscus lens having a concave surface facing an image, and a meniscus lens component having a concave surface facing the object which are disposed in order from the object along the optical axis, and
the first lens group includes a specified positive meniscus lens that satisfies the following conditional expressions,
$$0 < θ gFA + 0.0016 \times vdA - 0.646$$
$$1.6 < ndA < 1.85 , and$$
$$39.5 < vdA < 75. ,$$
where ndA: a refractive index of the specified positive meniscus lens with respect to d-line,
vdA: an Abbe number of the specified positive meniscus lens, and
θgFA: a partial dispersion ratio of the specified positive meniscus lens, defined by the following expression when it is assumed that a refractive index of the specified positive meniscus lens with respect to g-line is ngA, a refractive index of the specified positive meniscus lens with respect to F-line is nFA, and a refractive index of the specified positive meniscus lens with respect to C-line is nCA,
$$θ gFA = ( ngA - nFA ) / ( nFA - nCA ) .$$

3. The microscope objective lens according to claim 1, wherein the specified positive meniscus lens satisfies the following conditional expression,
$$- 10 < GAR 1 / DGA 1 < 1$$
where GAR1: a curvature radius of an object-side lens surface of the positive meniscus lens,
DGA1: a distance from the object-side lens surface of the positive meniscus lens to the object on the optical axis.

4. The microscope objective lens according to claim 1, wherein the specified positive meniscus lens satisfies the following conditional expression,
$$- 10 < GAR 2 / DGA 2 < 0$$
where GAR2: a curvature radius of an image-side lens surface of the positive meniscus lens, and
DGA2: a distance from the image-side lens surface of the positive meniscus lens to the object on the optical axis.

5. The microscope objective lens according to claim 1, wherein the specified positive meniscus lens satisfies the following conditional expression,
$$- 0.3 < ( GAR 2 - GAR 1 + GAL ) / TL < 0.3$$
where GAR1: a curvature radius of an object-side lens surface of the positive meniscus lens,
GAR2: a curvature radius of an image-side lens surface of the positive meniscus lens,
GAL: a length of the positive meniscus lens on the optical axis, and
TL: a distance in the microscope objective lens from a lens surface closest to the object to a lens surface closest to the image on the optical axis.

6. The microscope objective lens according to claim 1, wherein the positive meniscus lens is disposed in the first lens group to be closest to the object.

7. The microscope objective lens according to claim 6, wherein the first lens group includes a partial group that is movable along the optical axis.

8. The microscope objective lens according to claim 6, wherein
the first lens group includes an image-side lens that has a positive refractive power and is disposed closer to the image than the positive meniscus lens,
the image-side lens satisfies the following conditional expressions,
$$0 < θ gFB 1 + 0.015 \times vdB 1 - 0.6395 , and$$
$$vdB 1 < 40. ,$$
where vdB1: an Abbe number of the image-side lens,
θgFB1: a partial dispersion ratio of the image-side lens, defined by the following expression when it is assumed that a refractive index of the image-side lens with respect to g-line is ngB1, a refractive index of the image-side lens with respect to F-line is nFB1, and a refractive index of the image-side lens with respect to C-line is nCB1,
θgFB1=(ngB1−nFB1)/(nFB1−nCB1).

9. The microscope objective lens according to claim 1, wherein
the first lens group has a lens component that is disposed in the first lens group closest to the object and has a flat surface facing the object, and
the positive meniscus lens is disposed side by side with, and closer to the image than, the lens component.

10. The microscope objective lens according to claim 9, wherein
the second lens group is movable along the optical axis, and
the first lens group includes a partial group that is movable together with the second lens group along the optical axis.

11. The microscope objective lens according to claim 9, wherein
the first lens group includes an image-side lens that has a positive refractive power and is disposed closer to the image than the positive meniscus lens,
the image-side lens satisfies the following conditional expressions,
$$0 < θ gFA 2 + 0.0015 \times vdB 2 - 0.6395 ,$$
$$1.6 < ndB 2 < 1.85 , and$$
$$39.5 < vdB 2 < 75. ,$$
where ndB2: a refractive index of the image-side lens with respect to d-line,
vdB2: an Abbe number of the image-side lens, and
θgFB2: a partial dispersion ratio of the image-side lens, defined by the following expression when it is assumed that a refractive index of the image-side lens with respect to g-line is ngB2, a refractive index of the image-side lens with respect to F-line is nFB2, and a refractive index of the image-side lens with respect to C-line is nCB2,
$$θ gFB 2 = ( ngB 2 - nFB 2 ) / ( nFB 2 - nCB 2 ) ,$$

12. The microscope objective lens according to claim 9, wherein
the first lens group includes an image-side lens that has a positive refractive power and is disposed closer to the image than the positive meniscus lens,
the image-side lens satisfies the following conditional expressions,
$$0 < θ gFB 2 + 0.0016 \times vdB 2 - 0.646 ,$$
$$1.6 < ndB 2 < 1.85 , and$$
$$39.5 < vdB 2 < 75. ,$$
where ndB2: a refractive index of the image-side lens with respect to d-line,
vdB2: an Abbe number of the image-side lens, and
θgFB2: a partial dispersion ratio of the image-side lens, defined by the following expression when it is assumed that a refractive index of the image-side lens with respect to g-line is ngB2, a refractive index of the image-side lens with respect to F-line is nFB2, and a refractive index of the image-side lens with respect to C-line is nCB2,
$$θ gFB 2 = ( ngB 2 - nFB 2 ) / ( nFB 2 - nCB 2 ) ,$$

13. A microscope optical system, comprising: the microscope objective lens according to claim 1; and an imaging lens that focuses light from the microscope objective lens to form an image.

14. A microscope device, comprising the microscope objective lens according to claim 1.
